(19) United States
(12) Patent Application Publication
(10) Pub. No.: US 2018/0211556 A1
(43) Pub. Date: Jul. 26, 2018

(54) SYSTEMS AND METHODS FOR ADJUSTING DISPLAY LENGTHS OF SUBTITLES BASED ON A USER'S READING SPEED

(71) Applicant: Rovi Guides, Inc., San Carlos, CA (US)

(72) Inventor: Arun Sreedhara, Bangalore (IN)

(21) Appl. No.: 15/412,770

(22) Filed: Jan. 23, 2017

(51) Int. Cl. G09B 17/04; H04N 5/445; H04N 5/44; G09B 17/00

(52) U.S. Cl. CPC G09B 17/04; H04N 5/44513; H04N 2005/44526; G09B 17/003; H04N 5/4403

(57) ABSTRACT

Systems and methods for adjusting lengths of time subtitle segments are displayed based on the rate that a user reads words. For example, if a particular subtitle segment would not be displayed for a duration of time long enough for the user to read the words in the subtitle segment (e.g., based on the rate that the user reads words), the length of time the subtitle segment is displayed is increased.

### BACKGROUND

In order to increase the accessibility of media assets, many content providers provide subtitle text with media assets. The subtitle text visually displays dialog between characters and other auditory features of media assets to users. In some situations, particularly when watching foreign films where the subtitles are translated into a different language, a given subtitle text may disappear before the user has a chance to read all of it. Previous systems and methods could analyze the content of closed caption segments and adjust the speed of playback of a media asset based on how important a given scene was to the overall plot of the media asset. However, many users read text at different rates, so a blanket approach to lengthen the time certain subtitle text is displayed may not be appealing to many users. Additionally, modifying the playback speed of a media asset may obscure the action in the media asset, which may be undesirable to a user.

### SUMMARY

Accordingly, systems and methods are described herein for adjusting lengths of time subtitle segments are displayed based on the rate that a user reads words. For example, if a particular subtitle segment would not be displayed for a duration of time long enough for the user to read the words in the segment (e.g., based on the rate that the user reads words), the length of time that the subtitle segment is displayed is increased. Additionally, the audiovisual characteristics of the media asset may be analyzed while the subtitle segment is displayed to determine how to minimize the effect on the action in the media asset of increasing the length of time that the subtitle segment is displayed.

In some aspects, the media guidance application may determine a rate that a user reads words. For example, a media guidance application (e.g., executed on user equipment such as a set-top box) may access a user profile containing a value for the rate at which a user reads words. The value may be expressed in words per any unit of time (e.g., seconds, minutes, etc.) and may be converted in order to be compared to other rates. For example, if a rate is not already stored for a given user, the media guidance application may contain a calibration module that generates for display text and prompts a user to select a button (e.g., on a remote control) when they are finished reading the text to determine the rate at which the user reads.

In some embodiments, the media guidance application may access a calibration data structure. For example, the calibration data structure may be organized as a table, where each row contains fields with a string of text (or a pointer to a location in memory containing a string of text) as well as a value for the number of words in the string of text. The calibration data structure may additionally store the calibration (e.g., rate at which a user reads words) for specific users. The calibration data structure may be stored locally in memory or remotely at a remote server accessible via a communications network. The media guidance application may retrieve a calibration text passage and a value for a number of words in the calibration text passage from the calibration data structure. For example, the media guidance application may execute a database query language script such as an SQL script to retrieve a string of characters from a field in the calibration data structure as well as the number of words in the particular retrieved passage.

The media guidance application may, in response to receiving a first user input to determine the rate that the user reads words, generate for display the calibration text passage. For example, the media guidance application may generate a user interface with the text passage on a display in response to receiving a user input (e.g., using a remote control) to start the calibration. The media guidance application may determine an initial time at which the calibration text passage was first generated for display. For example, the media guidance application may store a value for the start time of the calibration based on the clock time when the user input to begin the calibration was received. The media guidance application may, in response to receiving a second user input that the user has finished reading the calibration text passage, determine an end time. For example, the media guidance application may receive a user input (e.g., using a remote control) indicating that the user has finished reading the calibration text passage and may store a value for the end time based on the clock time when the second user input was received.

The media guidance application may then calculate a calibration duration by subtracting the initial time from the end time. For example, if the user began a calibration at 12:02 pm and finished at 12:04 pm, the media guidance application, by subtracting the two values, may determine that the calibration duration (e.g., the time it took the user to read the calibration text passage) is 2 minutes. The media guidance application may calculate the rate that the user reads words by dividing the number of words in the calibration text passage by the calibration duration. For example, the media guidance application may divide the number of words in the calibration passage retrieved from the calibration data structure (e.g., 50 words) by the calibration duration determined during the calibration (e.g., 2 minutes) to determine the rate that the user reads words (e.g., 25 words per minute). In some embodiments, the media guidance application may generate multiple strings of text with words of varying difficulty and length to determine an average rate at which the user reads words. Alternatively or additionally, the media guidance application may track different rates the user reads words based on the difficulty of the words (e.g., based on their length), in order to better determine when and how much to increase the length a subtitle segment is generated for display.

In some embodiments, the media guidance application may determine, from an indication in a user profile for the user, a first time that the user opened textual content on a mobile device. For example, the media guidance application may receive data stored in a user profile on a cellular telephone that indicates a time stamp when a user opened an email, text message, webpage, or any other visually displayed text. The media guidance application may then determine a second time that the user closed the textual content after opening the textual content. For example, the media guidance application may receive data stored in the user profile on a cellular telephone indicating the time (e.g., via a time stamp) that an application or message was closed. The media guidance application may then determine the number of words in the textual content. For example, the media guidance application may access a webpage the user visited and determine (e.g., from the source code) how many words of text are displayed on the page.

The media guidance application may then calculate, based on the difference between the first time and the second time and the number of words in the textual content, the rate that the user reads words. For example, the media guidance application may determine based on the length a webpage was opened and how many words were on the webpage the rate at which the user reads. In other embodiments, the media guidance application may perform the calibration steps discussed above to determine the rate that the user reads words by retrieving data stored on any user device that indicates the amount of time a user spent reading a number of words (e.g., the time a user took to read a page of a book using an E-reader).

In some embodiments, the media guidance application determines that the rate that the user reads words is not available. For example, the user may not have entered a rate that they read words or utilized the calibration module to test how quickly they read words. In this situation, the media guidance application accesses a user profile associated with the user. For example, the media guidance application may access a user profile stored locally in memory or remote at a server accessible via a communications network. The media guidance application then retrieves information from the user profile. For example, the media guidance application may retrieve any data, such as demographic information, education, viewing history, etc. stored in the user profile that can be used to determine an estimate for the rate that the user reads words.

The media guidance application may access an average rate data structure containing average rates that groups read words. For example, the average rate data structure may be stored locally in storage or remotely at a server. The average rate data structure may be organized as a table, where each row contains fields with characteristics (e.g., education), a value (e.g., PhD) and an average rate that users with that characteristic and value read words (e.g., 50 words per minute). The media guidance application determines, based on the information from the user profile, that the user corresponds to a group. For example, the media guidance application may retrieve that the user received a PhD and based on comparing the retrieved value with the database, determine that the average rate users who have a PhD read words applies to the user. The media guidance application may then retrieve, from the average rate data structure, the average rate that users in the group read words as the rate that the user reads words. For example, the media guidance application may retrieve the value “50” from a field in the average rate data structure corresponding to 50 words per minute and store this value as the rate that the user reads words. Alternatively or additionally, the media guidance application may match multiple characteristics in the average rate data structure to information from the user profile and average the associated average rates.

The media guidance application may receive a user input from the user to view a media asset with subtitles. For example, the media guidance application may receive a user input (e.g., via a user input interface such as a touch screen) selecting a media asset (e.g., a movie) for viewing with subtitles on. The media guidance application may determine the identity of the user before (e.g., via a login screen to a user account) or after (e.g., based on facial recognition software and a camera identifying the user near a screen that is generating for display the media asset) selection of the media asset.

The media guidance application may access a subtitle data structure for the media asset containing start time codes and end time codes associated with subtitle segments. For example, the data structure may be organized as a table where each row contains time codes (e.g., in hours:minutes:seconds:frames) corresponding to the first and last frame where the subtitle text is to be generated for display, as well as a field with a string containing the text. Alternatively, the field may contain a pointer to a location in memory storing the string containing the text. In some embodiments, the subtitle data is obtained in real-time, or with a small buffer delay, in data packets from a media content source (e.g., a live television station such as ESPN). In this situation, a data packet may only contain indications of when to display or cease displaying a single subtitle segment and the associated text (e.g., a string of characters), as opposed to a table where every subtitle segment has been mapped to time codes already.

The media guidance application may retrieve a subtitle segment from the data structure with a start time code and an end time code. For example, the media guidance application may execute a database query language script such as SQL to retrieve text of a particular subtitle segment from a field in the data structure where the associated start time code corresponds to a current progress point in the media asset.

The media guidance application may calculate a displayed word rate for the subtitle segment. For example, based on the data retrieved from the data structure, the media guidance application may calculate the number of words per unit of time that will be generated for display for the given subtitle segment. The media guidance application determines a number of words in the segment. For example, the media guidance application may determine a word based on white space detection between consecutive characters for a given string of characters. For example, in a subtitle segment with text “I am your father,” the media guidance application may determine there are four words based on the three white spaces between characters. The media guidance application determines a duration by subtracting the start time code from the end time code. For example, if the start time code is 00:10:10:05 and the end time code is 00:11:10:05, the media guidance application may determine that the duration the subtitle segment will be generated for display is one minute. The media guidance application then divides the number of words by the duration to calculate the displayed word rate. For example, if the number of words is four and the total duration is one minute, then the displayed word rate is four words per minute.

The media guidance application may determine whether the rate that the user reads words is less than the displayed word rate for the subtitle segment. For example, the rate that the user reads words determined based on the calibration described above may be retrieved by the media guidance application from a user profile for the user. The media guidance application may then compare the rate that the user reads words (e.g., 20 words per minute) to the displayed word rate for the subtitle segment (e.g., 25 words per minute) to determine whether the user is able to read the words in the subtitle segment before they are no longer generated for display. If the media guidance application determines the rate that the user reads words is greater than the displayed word rate, the media guidance application may determine that no adjustment is necessary to the length the subtitle segment is generated for display.

In some embodiments, the media guidance application may calculate a rate factor by dividing the displayed word rate for the subtitle segment by the rate that the user reads words. For example, the media guidance application may calculate the rate factor to quantify how different the rate that the user reads words is from the displayed word rate. For example, the media guidance application may calculate a factor of 1.1 if the rate that the user reads words is 10 words per minute and the displayed word rate is 11 words per minute. The media guidance application may then determine the increased duration to display the subtitle segment by multiplying the duration by the rate factor, wherein the increased duration ends at a new end time code. For example, the media guidance application may determine from time codes in the subtitle data structure that a particular subtitle segment is to be displayed for 30 seconds. If the rate factor is 1.1, the media guidance application would determine that the subtitle segment needs to be displayed for 33 seconds (30*1.1) in order for every word to be read by the user. If the original end time code was 00:30:20:10, the media guidance application may store a new end time code (e.g., in a temporary data structure generated based on the subtitle data structure) with the values 00:30:23:10.

In some embodiments, the media guidance application may compare the rate factor to a minimum factor and a maximum factor. For example, if the rate that the user reads words and the displayed word rate are significantly different, there may be no way to lengthen the duration without obscuring the media asset (e.g., by slowing it down to a point that it is noticeable to a user). To prevent this situation, the media guidance application compares the rate factor to a threshold (e.g., the maximum factor). The media guidance application may use the minimum factor to determine whether the rates are sufficiently close and no adjustment to the duration is necessary (e.g., if the factor is 1.0001).

The media guidance application may, in response to determining that the rate factor is greater than the minimum factor and that the rate factor is less than the maximum factor, determine that the rate that the user reads words is less than the displayed word rate for the subtitle segment and that the duration of the subtitle segment can be adjusted by the rate factor. For example, if the media guidance application determines that the rate factor is 1.1 and the minimum factor is 1.001 and the maximum factor is 1.5, the media guidance application may extend the duration the subtitle segment is generated for display by a factor of 1.1, as described above. The media guidance application may, in response to determining that the rate factor is greater than the minimum factor and that the rate factor is greater than the maximum factor, determine that the rate that the user reads words is less than the displayed word rate for the subtitle segment and that the duration of the subtitle segment can not be adjusted by the rate factor. For example, if the media guidance application determines that the rate factor is 2 and the minimum factor is 1.001 and the maximum factor is 1.5, the media guidance application may determine that extending the duration the subtitle segment is generated for display such that the user can read every word will obscure the action in the media asset. The media guidance application may utilize other methods (e.g., changing the font size, transmitting the full text of the subtitle segment to a mobile device of the user etc.) to ensure the user is able to read the full subtitle segment.

The media guidance application may, in response to determining that the rate that the user reads words is less than the displayed word rate for the subtitle segment, increase the duration that the subtitle segment is generated for display. For example, the media guidance application may extend the length of time the subtitle segment is generated for display by displaying the subtitle segment past the end time code. In some embodiments, the media guidance application also generates, based on the data structure, a shifted data structure where the start and end time codes of subsequent subtitle segments are shifted by the amount of time the duration was increased to ensure subsequent subtitle segments are synchronized with the media asset.

In some embodiments, the media guidance application may determine, based on comparing the new end time code of the subtitle segment with the start time codes associated with the subtitle segments stored in the subtitle data structure, whether any subtitle segments overlap. For example, the media guidance application may determine that a subtitle segment should be increased by 10 seconds to allow a user to read the text of the segment. However, the media guidance application may not be able to extend the time the subtitle segment is generated for display for 10 seconds because another subtitle segment is to be generated for display 5 seconds after the end time code of the subtitle segment (e.g., based on retrieving start time codes of subtitle segments from the subtitle data structure and comparing them to the end time code). In this situation, the media guidance application may analyze the frames of the media asset that are generated for display (e.g., the audiovisual characteristics) to determine whether the playback can be slowed down or additional frames can be inserted to allow the user to read the subtitle segment. The media guidance application may, in response to determining that no subtitle segments overlap, generate the subtitle segment for display until the new end time code. For example, if there are no start time codes in the subtitle data structure that overlap with the new end time code, the media guidance application may increase the time that the subtitle segment is generated for display (e.g., display the subtitle segment until the new end time code) without analyzing the audiovisual characteristics of frames in the media asset.

In some embodiments, the media guidance application may determine frequencies of audio in frames between the start time code and the end time code for the subtitle segment. For example, the media guidance application may determine the frequencies of audio output at a given time during the playback of the media asset that correspond to frames during which the subtitle segment is displayed. The media guidance application compares the frequencies of audio in the frames to frequencies corresponding to human speech. For example, the media guidance application may determine whether frequencies corresponding to human speech (˜80-300 Hz) are output during particular frames. In some embodiments, the media guidance application may analyze the waveform, timbre, amplitude and any other characteristic of audio to more accurately determine whether audio that is output during a frame corresponds to human speech. The media guidance application, in response to determining that a frame does not contain the frequencies corresponding to human speech, stores an indication that the frame does not contain human speech. For example, once the media guidance application determines a given frame does not contain human speech, the media guidance application stores an indication (e.g., an identifier of the frame in a table or list) that, since the frame does not contain human speech, it can be shown for an increased duration without obscuring the content of the media asset. Once enough frames have been identified in this manner, the media guidance application may lengthen the frames (e.g., by inserting or duplicating frames) such that the duration that the subtitle segment is generated for display is stretched to allow the user more time to read the words in the subtitle segment.

In some embodiments, the media guidance application may compare visual components of two adjacent frames in the media asset between the start time code and the end time code for the subtitle segment. For example, the media guidance application may, based on object recognition algorithms (e.g., comparing the characteristics of a pixel map generated from the frame to known objects), compare the visual characteristics of one frame to another. For example, the media guidance application may determine that in a series of consecutive frames there is a low variance in the location and colors of pixels, indicating a still scene as opposed to an action scene. The media guidance application may then determine whether the visual components of the two adjacent frames are within a threshold similarity. For example, the media guidance application may determine whether 90% of the characteristics (e.g., a threshold number of pixels in pixel maps of the two images) match between two adjacent frames. The media guidance application may, in response to determining that the visual components of the two adjacent frames are within the threshold similarity, store an indication that the adjacent frames do not contain interesting visual content. For example, once the media guidance application determines two adjacent frames that do not vary a threshold amount in visual content, the media guidance application stores an indication (e.g., an identifier of the frame in a table or list) that the frames can be shown for an increased duration without obscuring the content of the media asset (e.g., because they are of a slowly changing landscape in a movie). Once enough frames have been identified in this manner, the media guidance application may lengthen the frames such that the duration that the subtitle segment is generated for display is stretched to allow the user more time to read the words in the subtitle segment.

In some embodiments, the media guidance application may, based on identifying the frames that have been identified as not containing human speech and not containing interesting visual content, determine an intersection of the frames that do not contain human speech or interesting visual content. For example, the media guidance application may determine that frames between 2-4 seconds in a media asset do not contain human speech and frames between 3-6 seconds in the media asset do not contain interesting visual content, as described above. The media guidance application may first extend (e.g., by duplicating or inserting frames) the time period the overlapping frames (e.g., frames between 3-4 seconds) are generated for display as there is a high likelihood these frames will not affect the quality and smoothness of playback of the media asset. For example, the media guidance application may duplicate frames that are already present (e.g., frames in the overlapping frames), or may insert new frames.

The media guidance application may then determine whether extending the overlapping frames results in the subtitle segment being displayed for an amount of time sufficient for the user to fully read the text of the subtitle segment. For example, the new end time code (e.g., representing the end of the increased duration the subtitle segment should be generated for display so the user can read the text of the segment) may not be reached based solely on extending the duration that the overlapping frames are generated for display. In this case, the media guidance application may extend the duration that frames that do not contain human speech are generated for display. For example, in order to not obscure the voices of actors in the media asset and ensure the subtitle is synchronized with the media asset, the media guidance application extends frames that do not contain human speech (but contain interesting visual content) before extending frames that do not contain interesting content (but do contain human speech). As discussed above, in some embodiments, the media guidance application also generates, based on the subtitle data structure, a shifted data structure where the start and end time codes of subsequent subtitle segments are shifted by the amount of time the duration was increased to ensure subsequent subtitle segments are synchronized with the media asset.

In some embodiments, the media guidance application may extend intervals not containing human speech and/or interesting visual content proportional to the length of the interval. For example, the media guidance application may determine two intervals containing frames that can be generated for display for an increased amount of time as described above. As a specific example, the media guidance application may determine a 1 second interval and a 5 second interval inside the segment the subtitle is to be generated for display. The media guidance application may extend the shorter interval (e.g., the 1 second interval) and the longer interval (e.g., the 5 second interval) by a factor. For example, if the factor is 2, the 1 second interval would be 2 seconds long and the 5 second interval would be 10 seconds long. Alternatively or additionally, the factor may represent an upper bound. For example, the media guidance application may extend the 1 second segment by no more than 1 second. This prevents a situation where the media guidance application may extend the shorter segment by a large factor and obscure the playback of the media asset (e.g., by making it appear to be in slow-motion during that interval) while not extending the longer segment.

In some embodiments, the media guidance application may, subsequent to the subtitle segment being generated for display, receive a user input to obtain more time to view the subtitle segment from the user. For example, the media guidance application may receive a user input (e.g., via a remote control) to pause the media asset while a subtitle is displayed. The media guidance application may analyze the difference between the rate that the user reads words and the displayed word rate to determine if the user input to pause the media asset is due to reading the subtitles or another purpose. For example, if a user pauses the media asset to go to dinner, the pause time will be far greater than if the user needs to read one additional word and the media guidance application may disregard the pause.

The media guidance application may increase the rate that the user reads words based on the received selection. For example, the media guidance application may analyze the length of time the media asset was paused and calculate a rate that the user read the currently displayed subtitle segment and update (e.g., by replacing or averaging) the rate that the user reads words. Alternatively or additionally, the media guidance application may only update the rate that the user reads words if a threshold number of user inputs are received. For example, if the user pauses five times for five seconds while different subtitle segments are generated for display and the threshold is four user inputs, the media guidance application will update the rate that the user reads words.

The media guidance application may generate the subtitle segment for display for the increased duration. For example, after determining the increased duration that will allow the user to read the words in the subtitle segment, the media guidance application generates the text in the subtitle segment for display overlaid on the media asset for the increased amount of time (e.g., 10 seconds longer).

It should be noted the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a media asset displayed with a subtitle segment, in accordance with some embodiments of the disclosure;

FIG. 2 shows an illustrative depiction of increasing the duration subtitle segments are displayed, in accordance with some embodiments of the disclosure;

FIG. 3 shows an illustrative depiction of a table containing time codes corresponding to subtitle segments, in accordance with some embodiments of the disclosure;

FIG. 4 shows an illustrative example of a display screen for use in accessing media content in accordance with some embodiments of the disclosure;

FIG. 5 shows another illustrative example of a display screen used access media content in accordance with some embodiments of the disclosure;

FIG. 6 is a block diagram of an illustrative user equipment device in accordance with some embodiments of the disclosure;

FIG. 7 is a block diagram of an illustrative media system in accordance with some embodiments of the disclosure;

FIG. 8 is a flowchart of illustrative steps for determining whether a media asset was generated for display longer than a threshold, in accordance with some embodiments of the disclosure;

FIG. 9 is a flowchart of illustrative steps for determining a rate that a user reads words, in accordance with some embodiments of the disclosure;

FIG. 10 is a flowchart of illustrative steps for retrieving a subtitle segment for a media asset from a data structure, in accordance with some embodiments of the disclosure;

FIG. 11 is a flowchart of illustrative steps for determining whether a rate that a user reads words is less than a displayed word rate for a subtitle segment, in accordance with some embodiments of the disclosure; and

FIG. 12 is a flowchart of illustrative steps for increasing the duration that a subtitle segment is generated for display, in accordance with some embodiments of the disclosure.

### DETAILED DESCRIPTION

Systems and methods are described for adjusting lengths of time subtitle segments are displayed based on the rate that a user reads words. For example, if a particular subtitle segment would not be displayed for a duration of time long enough for the user to read the words in the segment (e.g., based on the rate that the user reads words), the length the subtitle segment is displayed is increased. Additionally, the audiovisual characteristics of the media asset may be analyzed while the subtitle segment is displayed to determine how to minimize the effect on the action in the media asset of increasing the length of time that the subtitle segment is displayed.

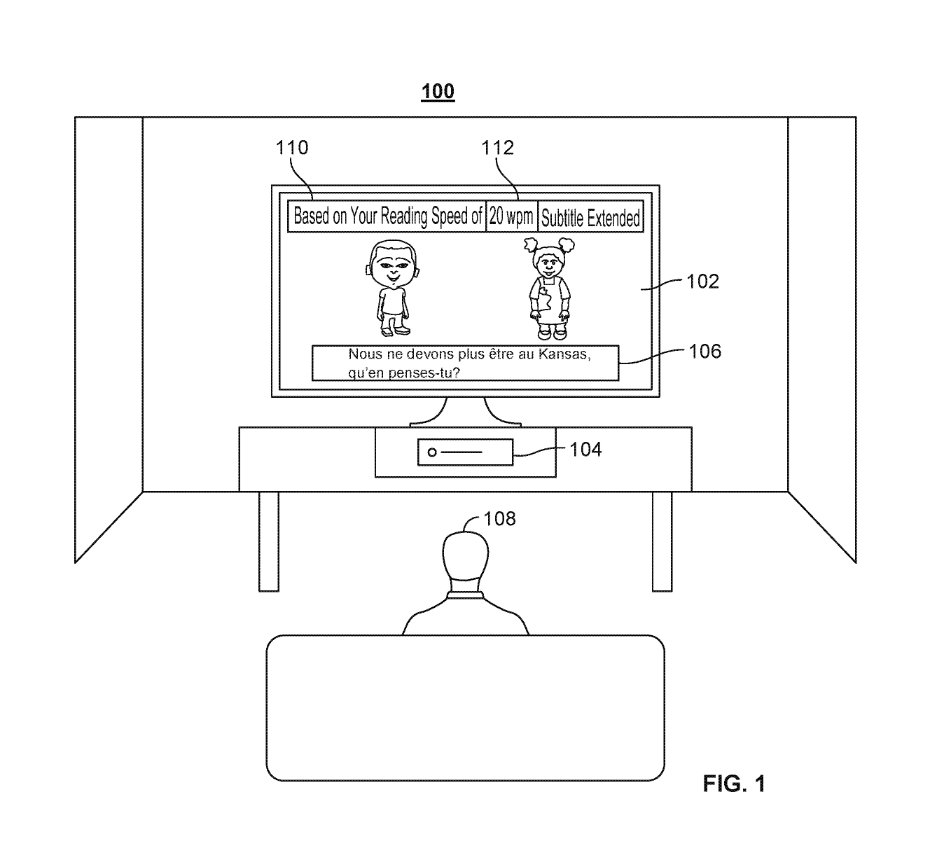

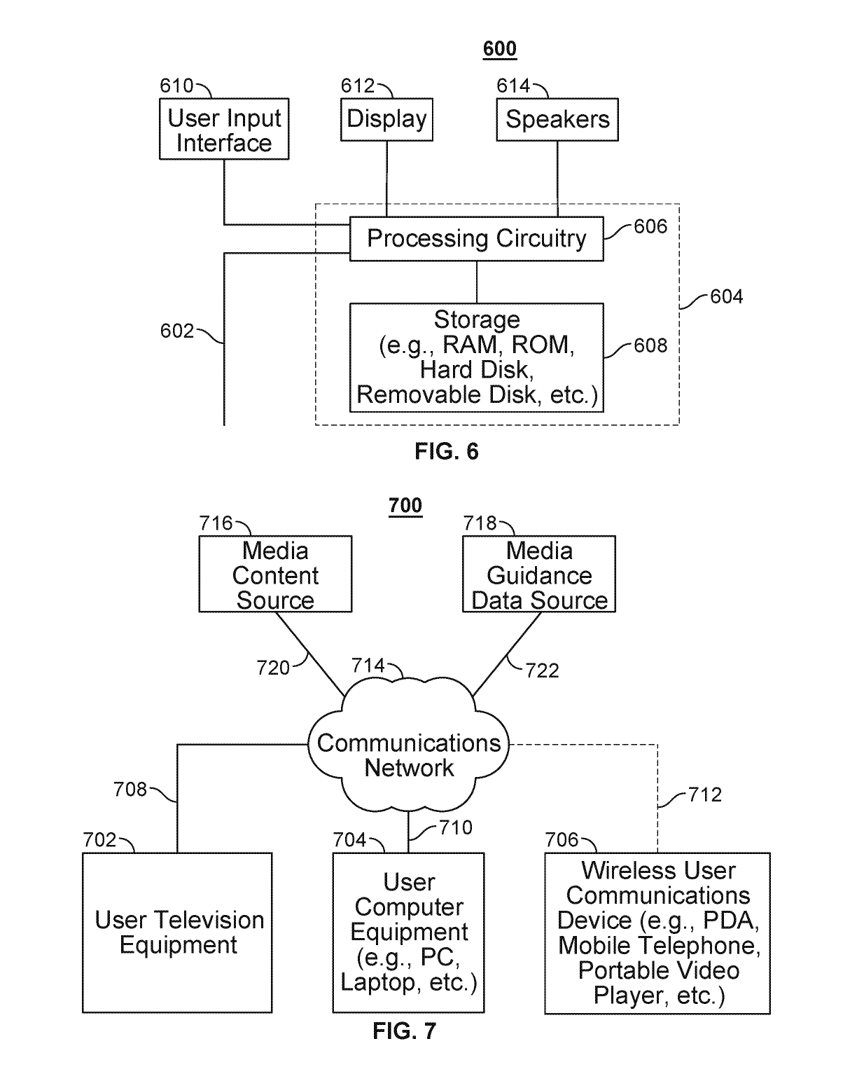

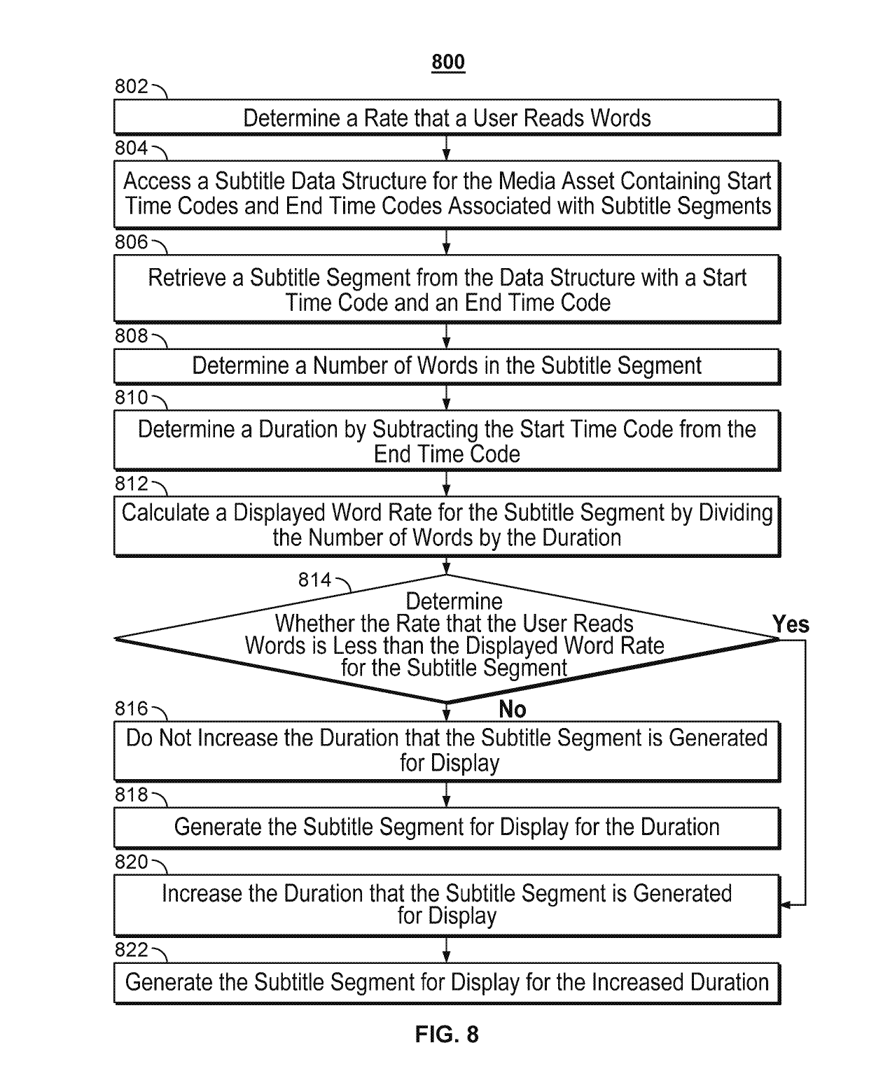

FIG. 1 shows an illustrative example of a media asset displayed with a subtitle segment, in accordance with some embodiments of the disclosure. For example, display 100 may be coupled to user equipment device 104 which executes a media guidance application in order to display media asset 102. After receiving a request to view media asset 102 with subtitles from user 108, the media guidance application may generate for display subtitle segments (e.g., subtitle segment 106) for an extended length of time (e.g., as indicated by notification 110) depending on the rate that a user reads words (e.g., rate 112), as described further below. Display 100 may appear on one or more user devices (e.g., any of the devices listed in FIGS. 6-7 below). Moreover, the media guidance application may use one or more of the processes described in FIGS. 8-12 to generate display 100 or any of the features described therein.

As referred to herein, a “subtitle segment” should be understood as alphanumeric characters, symbols, or special characters related to a media asset that are presented simultaneously during a portion of the media asset. For example, the alphanumeric characters, symbols, or special characters may describe dialog between characters, words in a musical number, or any other auditory feature in the media asset. In some embodiments, the subtitle segment may be overlaid on the media asset. In other embodiments, the subtitle segment may be transmitted to a second screen device (e.g., a mobile telephone of a user viewing a media asset).

In some aspects, the media guidance application may determine a rate that a user reads words. For example, a media guidance application (e.g., executed on user equipment device 104) may access a user profile (e.g., for user 108) containing a value for the rate at which a user reads words (e.g., rate 112). The value may be expressed in words per any unit of time (e.g., seconds, minutes, etc.) and may be converted in order to be compared to other rates. For example, the rate that the user reads words may be expressed in words per minute, abbreviated as “wpm.” For example, if a rate is not already stored for a given user, the media guidance application may contain a calibration module that generates for display text and prompts a user to select a button (e.g., on a remote control) when they are finished reading the text to determine the rate at which the user reads.

In some embodiments, the media guidance application may access a calibration data structure. For example, the calibration data structure may be organized as a table, where each row contains fields with a string of text (or a pointer to a location in memory containing a string of text) as well as a value for the number of words in the string of text. The calibration data structure may additionally store the calibration (e.g., rate at which a user reads words) for specific users (e.g., user 108). The calibration data structure may be stored locally in memory (e.g., of user equipment device 104) or remotely at a remote server accessible via a communications network. The media guidance application may retrieve a calibration text passage and a value for a number of words in the calibration text passage from the calibration data structure. For example, the media guidance application may execute a database query language script such as an SQL script to retrieve a string of characters from a field in the calibration data structure as well as the number of words in the particular retrieved passage.

The media guidance application may, in response to receiving a first user input to determine the rate that the user reads words, generate for display the calibration text passage. For example, the media guidance application may generate a user interface with the text passage on a display (e.g., display 100) in response to receiving a user input (e.g., using a remote control) from the user (e.g., user 108) to start the calibration. The media guidance application may determine an initial time at which the calibration text passage was first generated for display. For example, the media guidance application may store a value for the start time of the calibration based on the clock time when the user input to begin the calibration was received. The media guidance application may, in response to receiving a second user input that the user has finished reading the calibration text passage, determine an end time. For example, the media guidance application may receive a user input (e.g., using a remote control) indicating that the user has finished reading the calibration text passage and may store a value for the end time based on the clock time when the second user input was received.

The media guidance application may then calculate a calibration duration by subtracting the initial time from the end time. For example, if the user (e.g., user 108) began a calibration at 12:02 pm and finished at 12:04 pm, the media guidance application, by subtracting the two values, may determine that the calibration duration (e.g., the time it took the user to read the calibration text passage) is 2 minutes. The media guidance application may calculate the rate that the user reads words (e.g., rate 112) by dividing the number of words in the calibration text passage by the calibration duration. For example, the media guidance application may divide the number of words in the calibration passage retrieved from the calibration data structure (e.g., 40 words) by the calibration duration determined during the calibration (e.g., 2 minutes) to determine the rate that the user reads words (e.g., rate 112). In some embodiments, the media guidance application may generate for display (e.g., on display 100) multiple strings of text with words of varying difficulty and length to determine an average rate at which the user reads words. Alternatively or additionally, the media guidance application may track different rates the user reads words based on the difficulty of the words (e.g., based on their length), in order to better determine when and how much to increase the length a subtitle segment is generated for display.

In some embodiments, the media guidance application may determine, from an indication in a user profile for the user, a first time that the user opened textual content on a mobile device. For example, the media guidance application may receive data stored in a user profile (e.g., for user 108) on a cellular telephone that indicates a time stamp when the user opened an email, text message, webpage, or any other visually displayed text. The media guidance application may then determine a second time that the user closed the textual content after opening the textual content. For example, the media guidance application may receive data stored in the user profile on a cellular telephone indicating the time (e.g., via a time stamp) that an application or message was closed. The media guidance application may then determine the number of words in the textual content. For example, the media guidance application may access a webpage the user visited and determine (e.g., from the source code) how many words of text are displayed on the page.

The media guidance application may then calculate, based on the difference between the first time and the second time and the number of words in the textual content, the rate that the user reads words. For example, the media guidance application may determine based on the length a webpage was opened and how many words were on the webpage the rate at which the user reads words (e.g., rate 112). In other embodiments, the media guidance application may perform the calibration steps discussed above to determine the rate that the user reads words by retrieving data stored on any user device that indicates the amount of time a user spent reading a number of words (e.g., the time a user took to read a page of a book using an E-reader).

In some embodiments, the media guidance application determines that the rate that the user reads words is not available. For example, the user (e.g., user 108) may not have entered a rate that he or she read words or utilized the calibration module (e.g., where a test passage is presented to the user as described above) to test how quickly he or she reads words. In this situation, the media guidance application accesses a user profile associated with the user. For example, the media guidance application may access a user profile stored locally in memory (e.g., of user equipment device 104) or remote at a server accessible via a communications network. The media guidance application then retrieves information from the user profile. For example, the media guidance application may retrieve any data, such as demographic information, education, viewing history, etc. stored in the user profile that can be used to determine an estimate for the rate that the user reads words (e.g., rate 112).

The media guidance application may access an average rate data structure containing average rates that groups read words. For example, the average rate data structure may be stored locally in storage or remotely at a server. The average rate data structure may be organized as a table, where each row contains fields with characteristics (e.g., education), a value (e.g., PhD) and an average rate that users with that characteristic and value read words (e.g., 50 words per minute). The media guidance application determines, based on the information from the user profile, that the user (e.g., user 108) corresponds to a group. For example, the media guidance application may retrieve that the user received a PhD and based on comparing the retrieved value with the database, determine that the average rate users who have a PhD read words applies to the user. The media guidance application may then retrieve, from the average rate data structure, the average rate that users in the group read words as the rate that the user reads words (e.g., rate 112). For example, the media guidance application may retrieve the value “50” from a field in the average rate data structure corresponding to 50 words per minute and store this value as the rate that the user reads words (e.g., in a user profile corresponding to user 108). Alternatively or additionally, the media guidance application may match multiple characteristics in the average rate data structure to information from the user profile and average the associated average rates.

The media guidance application may receive a user input from the user to view a media asset with subtitles. For example, the media guidance application may receive a user input (e.g., via a user input interface such as a touch screen) from the user (e.g., user 108) selecting a media asset (e.g., media asset 102) for viewing with subtitles on. The media guidance application may determine the identity of the user (e.g., user 108) before (e.g., via a login screen to a user account) or after (e.g., based on facial recognition software and a camera identifying the user near a screen that is generating for display the media asset) selection of the media asset.

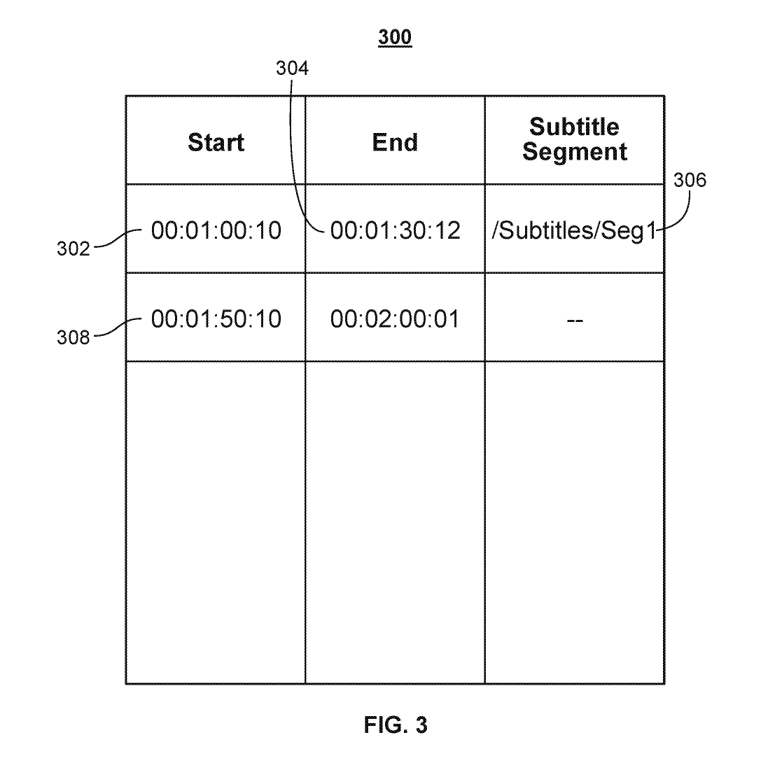

The media guidance application may access a subtitle data structure for the media asset containing start time codes and end time codes associated with subtitle segments. For example, as described further below with respect to FIG. 3, the data structure may be organized as a table where each row contains time codes (e.g., in hours:minutes:seconds:frames) corresponding to the first and last frame where the subtitle text is to be generated for display, as well as a field with a string containing the text (e.g., of subtitle segment 106). Alternatively, the field may contain a pointer to a location in memory storing the string containing the text. In some embodiments, the subtitle data is obtained in real-time, or with a small buffer delay, in data packets from a media content source (e.g., a live television station such as ESPN). In this situation, a data packet may only contain indications of when to display or cease displaying a single subtitle segment and the associated text (e.g., a string of characters), as opposed to a table where every subtitle segment has been mapped to time codes already.

The media guidance application may retrieve a subtitle segment from the data structure with a start time code and an end time code. For example, the media guidance application may execute a database query language script such as SQL to retrieve text characters or other data of a particular subtitle segment (e.g., subtitle segment 106) from a particular field in the table.

The media guidance application may calculate a displayed word rate for the subtitle segment. For example, based on the data retrieved from the data structure, the media guidance application may calculate the number of words per unit of time that will be generated for display for the given subtitle segment (e.g., subtitle segment 106). The media guidance application then determines a number of words in the segment. For example, the media guidance application may determine a word based on white space detection between consecutive characters for a given string of characters. For example, in a subtitle segment with text “I am your father,” the media guidance application may determine there are four words based on the three white spaces between characters. The media guidance application determines a duration by subtracting the start time code from the end time code. For example, if the start time code is 00:10:10:05 and the end time code is 00:11:10:05, the media guidance application may determine that the duration the subtitle segment will be generated for display (e.g., on display 100) is one minute. The media guidance application then divides the number of words by the duration to calculate the displayed word rate. For example, if the number of words is four and the total duration is one minute, then the displayed word rate is four words per minute.

The media guidance application may determine whether the rate that the user reads words is less than the displayed word rate for the subtitle segment. For example, the rate that the user reads words (e.g., rate 112) may be retrieved by the media guidance application from a user profile for the user (e.g., user 108). The media guidance application may then compare the rate that the user reads words (e.g., 20 words per minute) to the displayed word rate for the subtitle segment (e.g., 25 words per minute) to determine whether the user is able to read the words in the subtitle segment (e.g., subtitle segment 106) before they are no longer generated for display. If the media guidance application determines the rate that the user reads words is greater than the displayed word rate, the media guidance application may determine that no adjustment is necessary to the length the subtitle segment is generated for display.

The media guidance application may, in response to determining that the rate that the user reads words is less than the displayed word rate for the subtitle segment, increase the duration that the subtitle segment is generated for display. For example, the media guidance application may extend the length of time the subtitle segment (e.g., subtitle segment 106) is generated for display (e.g., on display 100) by displaying the subtitle segment past the end time code. In some embodiments, the media guidance application also generates, based on the data structure, a shifted data structure where the start and end time codes of subsequent subtitle segments are shifted by the amount of time the duration was increased to ensure subsequent subtitle segments are synchronized with the media asset. In some embodiments, the media guidance application generates a notification that a particular subtitle segment was extended. For example, the media guidance application may optionally present a text notification (e.g., notification 110) to the user (e.g., user 108) indicating that the subtitle segment was extended.

The media guidance application may generate the subtitle segment for display for the increased duration. For example, after determining the increased duration that will allow the user (e.g., user 108) to read the words in the subtitle segment (e.g., subtitle segment 106), the media guidance application generates the text in the subtitle segment for display overlaid on the media asset (e.g., media asset 102) for the increased amount of time (e.g., 10 seconds longer).

In some embodiments, the media guidance application may, subsequent to the subtitle segment being generated for display, receive a user input to obtain more time to view the subtitle segment from the user. For example, the media guidance application may receive a user input (e.g., via a remote control) to pause the media asset (e.g., media asset 102) while a subtitle (e.g., subtitle segment 106) is displayed (e.g., on display 100). The media guidance application may analyze the difference between the rate that the user reads words (e.g., rate 112) and the displayed word rate to determine if the user input to pause the media asset is due to reading the subtitles or another purpose. For example, if a user (e.g., user 108) pauses the media asset to go to dinner, the pause time will be far greater than if the user needs to read one additional word and the media guidance application may disregard the pause.

The media guidance application may increase the rate that the user reads words based on the received selection. For example, the media guidance application may analyze the length of time the media asset (e.g., media asset 102) was paused and calculate a rate that the user read the currently displayed subtitle segment and update (e.g., by replacing or averaging) the rate that the user reads words (e.g., rate 112). Alternatively or additionally, the media guidance application may only update the rate that the user reads words if a threshold number of user inputs are received. For example, if the user pauses five times for five seconds while different subtitle segments are generated for display and the threshold is four user inputs, the media guidance application will update the rate that the user reads words.

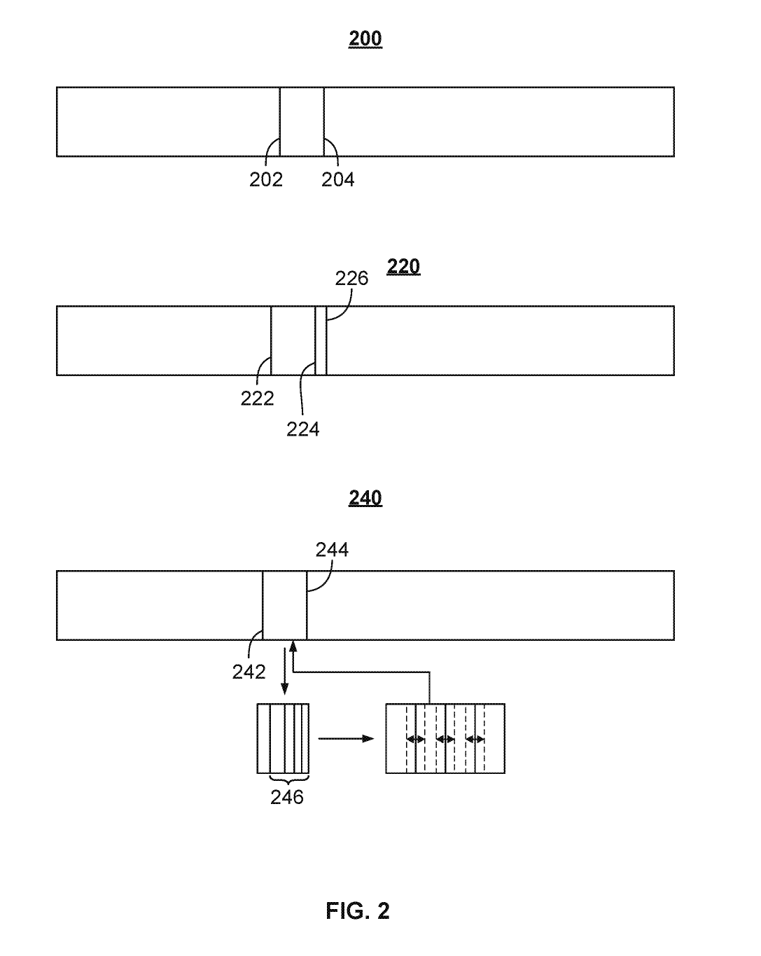

FIG. 2 shows an illustrative depiction of increasing the duration subtitle segments are displayed, in accordance with some embodiments of the disclosure. For example, the total duration of a media asset is depicted by progress bars 200, 220, and 240. Progress bar 200 includes start time code 202 and end time code 204, representing the duration a subtitle segment is to be generated for display (e.g., as indicated in a subtitle data structure, as described further below with respect to FIG. 3). Progress bars 220 and 240 depict two methods of increasing the length of time a subtitle segment is generated for display, and may be implemented separately or in combination. One or more user devices (e.g., any of the devices listed in FIGS. 6-7 below) may execute the media guidance application, which may use one or more of the processes described in FIGS. 8-12 to increase the length of time a subtitle segment is generated for display.

FIG. 2 includes progress bar 200, which depicts the duration that a particular subtitle segment is generated for display by default (e.g., from start time code 202 to end time code 204) based on the subtitle data structure (described further below with respect to FIG. 3). However, as described above with respect to FIG. 1, because of the variable rate that users read text, the default duration that the subtitle segment is generated for display may be too short for a given user to read (e.g., the displayed word rate is greater than the rate that the user reads words).

FIG. 2 also includes progress bar 220, which depicts an increased duration that a particular subtitle segment is generated for display. Progress bar 220 includes start time code 222 and end time code 224 analogous to progress bar 200, but also includes new end time code 226. New end time code 226 is at a progress point further in the media asset that, when the subtitle segment is generated for display until, will allow the user to fully read the text of the subtitle segment.

In some embodiments, in order to calculate the increased duration to generate the subtitle segment for display (e.g., new end time code 226) the media guidance application may calculate a rate factor. The media guidance application may calculate a rate factor by dividing the displayed word rate for the subtitle segment by the rate that the user reads words. For example, the media guidance application may calculate the rate factor to quantify how different the rate that the user reads words is from the displayed word rate. For example, the media guidance application may calculate a factor of 1.1 if the rate that the user reads words is 10 words per minute and the displayed word rate is 11 words per minute. The media guidance application may then determine the increased duration (e.g., from start time code 222 to new end time code 226 as opposed to from start time code 222 to end time code 224) to display the subtitle segment by multiplying the duration by the rate factor, wherein the increased duration ends at a new end time code (e.g., new end time code 226). For example, the media guidance application may determine from time codes in the subtitle data structure that a particular subtitle segment is to be displayed for 30 seconds. If the rate factor is 1.1, the media guidance application would determine that the subtitle segment needs to be displayed for 33 seconds (30*1.1) in order for every word to be read by the user. If the original end time code was 00:30:20:10, the media guidance application may store a new end time code (e.g., in a temporary data structure generated based on the subtitle data structure) with the values 00:30:23:10.

In some embodiments, the media guidance application may compare the rate factor to a minimum factor and a maximum factor. For example, if the rate that the user reads words and the displayed word rate are significantly different, there may be no way to lengthen the duration without obscuring the media asset (e.g., by having overlapping subtitle segments). To prevent this situation, the media guidance application compares the rate factor to a threshold (e.g., the maximum factor). The media guidance application may compare the rate factor to the minimum factor to determine whether the rates are sufficiently close and no adjustment to the duration is necessary (e.g., if the factor is 1.0001).

The media guidance application may, in response to determining that the rate factor is greater than the minimum factor and that the rate factor is less than the maximum factor, determine that the rate that the user reads words is less than the displayed word rate for the subtitle segment and that the duration of the subtitle segment can be adjusted by the rate factor. For example, if the media guidance application determines that the rate factor is 1.1 and the minimum factor is 1.001 and the maximum factor is 1.5, the media guidance application may extend the duration the subtitle segment is generated for display by a factor of 1.1 (e.g., to new end time code 226), as described above. The media guidance application may, in response to determining that the rate factor is greater than the minimum factor and that the rate factor is greater than the maximum factor, determine that the rate that the user reads words is less than the displayed word rate for the subtitle segment and that the duration of the subtitle segment can not be adjusted by the rate factor (e.g., because new end time code 226 is much later in the media asset). For example, if the media guidance application determines that the rate factor is 2 and the minimum factor is 1.001 and the maximum factor is 1.5, the media guidance application may determine that extending the duration the subtitle segment is generated for display such that the user can read every word will obscure the action in the media asset. The media guidance application may utilize other methods (e.g., changing the font size, transmitting the full text of the subtitle segment to a mobile device of the user etc.) to ensure the user is able to read the full subtitle segment.

In some embodiments, the media guidance application may determine, based on comparing the new end time code of the subtitle segment with the start time codes associated with the subtitle segments stored in the subtitle data structure, whether any subtitle segments overlap. For example, the media guidance application may determine that a subtitle segment should be increased by 10 seconds (e.g., to new end time code 226) to allow a user to read the text of the segment. However, the media guidance application may not be able to extend the time the subtitle segment is generated for display for 10 seconds because another subtitle segment is to be generated for display 5 seconds after the end time code (e.g., end time code 224) of the subtitle segment (e.g., based on retrieving start time codes of subtitle segments from the subtitle data structure and comparing them to the end time code). In this situation, the media guidance application may analyze the frames of the media asset that are generated for display (e.g., the audiovisual characteristics) to determine whether the playback can be slowed down or additional frames can be inserted to allow the user to read the subtitle segment, as described further below with respect to progress bar 240.

The media guidance application may, in response to determining that no subtitle segments overlap, generate the subtitle segment for display until the new end time code. For example, if there are no start time codes in the subtitle data structure that overlap with the new end time code (e.g., new end time code 226), the media guidance application may increase the time that the subtitle segment is generated for display (e.g., display the subtitle segment until the new end time code) without analyzing the audiovisual characteristics of frames in the media asset (e.g., as described below with respect to progress bar 240).

FIG. 2 also includes progress bar 240, which depicts an increased duration that a particular subtitle segment is generated for display. Progress bar 240 includes start time code 242 and end time code 244 analogous to progress bars 200 and 220. However, progress bar 240 shows a situation where extending the duration the subtitle segment is generated for display is not possible because another subtitle segment would overlap (e.g., as described above). In order to increase the amount of time that the subtitle segment is generated for display, some of the frames between start time code 242 and end time code 244 are generated for display an extended amount of time (e.g., frames 246). The media guidance application determines the particular frames to extend (e.g., frames 246) based on analyzing the audiovisual content of the frames and determining which frames can be generated for an extended period of time without obscuring the media asset.

In some embodiments, the media guidance application may determine frequencies of audio in frames between the start time code and the end time code for the subtitle segment. For example, the media guidance application may determine the frequencies of audio output at a given time during the playback of the media asset that correspond to frames during which the subtitle segment is displayed. The media guidance application compares the frequencies of audio in the frames to frequencies corresponding to human speech. For example, the media guidance application may determine whether frequencies corresponding to human speech (˜80-300 Hz) are output during particular frames (e.g., frames 246). In some embodiments, the media guidance application may analyze the waveform, timbre, amplitude and any other characteristic of audio to more accurately determine whether audio that is output during a frame corresponds to human speech. The media guidance application, in response to determining that a frame does not contain the frequencies corresponding to human speech, stores an indication to increase a length of time that the frame is generated for display. For example, once the media guidance application determines a given frame (e.g., one of frames 246) does not contain human speech, the media guidance application stores an indication (e.g., an identifier of the frame) that it can be shown for an increased duration without obscuring the content of the media asset. Once enough frames have been identified in this manner (e.g., extending all of frames 246, the media guidance application may lengthen the frames such that the duration that the subtitle segment is generated for display is stretched to allow the user more time to read the words in the subtitle segment.

In some embodiments, the media guidance application may compare visual components of two adjacent frames in the media asset between the start time code and the end time code for the subtitle segment. For example, the media guidance application may, based on object recognition algorithms (e.g., comparing the characteristics of a pixel map generated from the frame to known objects), compare the visual characteristics of one frame to another (e.g., frames 246). For example, the media guidance application may determine that in a series of consecutive frames (e.g., a subset of frames 246) there is a low variance in the location and colors of pixels, indicating a still scene as opposed to an action scene. The media guidance application may then determine whether the visual components of the two adjacent frames are within a threshold similarity. For example, the media guidance application may determine whether 90% of the characteristics (e.g., a threshold number of pixels in pixel maps of the two images) match between two adjacent frames. The media guidance application may, in response to determining that the visual components of the two adjacent frames are within the threshold similarity, store an indication to increase a length of time that both of the two adjacent frames are generated for display. For example, once the media guidance application determines two adjacent frames that do not vary a threshold amount in visual content, the media guidance application stores an indication (e.g., an identifier of the frame) that the frames can be shown for an increased duration without obscuring the content of the media asset (e.g., because they are of a slowly changing landscape in a movie). Once enough frames have been identified in this manner (e.g., all of frames 246), the media guidance application may lengthen the frames such that the duration that the subtitle segment is generated for display is stretched to allow the user more time to read the words in the subtitle segment.

In some embodiments, the media guidance application may, based on identifying the frames that have been identified as not containing human speech and not containing interesting visual content, determine an intersection of the frames that do not contain human speech or interesting visual content. For example, based on the stored indications (e.g., in a table or list) that particular frames do not contain interesting visual content and/or human speech, the media guidance application may determine that frames between 2-4 seconds in a media asset do not contain human speech and frames between 3-6 seconds in the media asset do not contain interesting visual content, as described above. The media guidance application may first extend (e.g., by duplicating or inserting frames) the time period the overlapping frames (e.g., frames between 3-4 seconds) are generated for display (e.g., frames 246 are extended) as there is a high likelihood these frames will not affect the quality and smoothness of playback of the media asset. For example, the media guidance application may duplicate frames that are already present (e.g., frames in the overlapping frames), or may insert new frames.

The media guidance application may determine that no frames without human speech overlap with frames containing uninteresting visual content. In this case, the media guidance application may extend the duration that frames that do not contain human speech are generated for display. For example, in order to not obscure the voices of actors in the media asset and ensure the subtitle is synchronized with the media asset, the media guidance application extends frames that do not contain human speech (but contain interesting visual content) before extending frames that do not contain interesting content (but do contain human speech).

In some embodiment, the media guidance application may then determine whether extending the overlapping frames results in the subtitle segment being displayed for an amount of time sufficient for the user to fully read the text of the subtitle segment. For example, the new end time code (e.g., an amount of time past end time code 244 that will allow the user to read the words in the subtitle segment) may not be reached based solely on extending the duration that the overlapping frames are generated for display. In this case, the media guidance application may extend the duration that frames that do not contain human speech or interesting visual content are generated for display. For example, in order to not obscure the voices of actors in the media asset and ensure the subtitle is synchronized with the media asset, the media guidance application extends frames that do not contain human speech (but contain interesting visual content) before extending frames that do not contain interesting content (but do contain human speech). As discussed further below with respect to FIG. 3, in some embodiments, the media guidance application also generates, based on the subtitle data structure, a shifted data structure where the start and end time codes of subsequent subtitle segments are shifted by the amount of time the duration was increased to ensure subsequent subtitle segments are synchronized with the media asset.

In some embodiments, the media guidance application may extend intervals not containing human speech and/or interesting visual content proportional to the length of the interval. For example, the media guidance application may determine two intervals (e.g., between start time code 242 to end time code 244) containing frames that can be generated for display for an increased amount of time as described above. As a specific example, the media guidance application may determine a 1 second interval and a 5 second interval inside the segment the subtitle is to be generated for display (e.g., from start time code 242 to end time code 244). The media guidance application may extend the shorter interval (e.g., the 1 second interval) and the longer interval (e.g., the 5 second interval) by a factor. For example, if the factor is 2, the 1 second interval would be 2 seconds long and the 5 second interval would be 10 seconds long. Alternatively or additionally, the factor may represent an upper bound. For example, the media guidance application may extend the 1 second segment by no more than 1 second. This prevents a situation where the media guidance application may extend the shorter segment by a large factor and obscure the playback of the media asset (e.g., by making it appear to be in slow-motion during that interval) while not extending the longer segment.

In some embodiments, the media guidance application may lengthen frames between the start time code and the end time code a variable amount based on their content. For example, the media guidance application may lengthen the amount of time a first frame is generated for display by 1 second and a second frame by 2 seconds. The media guidance application may determine the amount of time to lengthen a given frame based on the audiovisual analysis of the frame. For example, if the media guidance application determines a frame has almost no variation in visual content (e.g., based on a pixel map as described above) from adjacent frames, as well as no human speech in the audio track, the frame may be lengthened more than if it only had no human speech.

FIG. 3 shows an illustrative depiction of a table containing time codes corresponding to subtitle segments, in accordance with some embodiments of the disclosure. For example, table 300 may be organized such that each row corresponds to a different subtitle segment in a media asset. Table 300 may be stored in memory (e.g., storage as described in FIG. 6) on one or more user devices (e.g., any of the devices listed in FIGS. 6-7 below). Moreover, the media guidance application may use one or more of the processes described in FIGS. 8-12 below to generate table 300 or any of the features described therein.

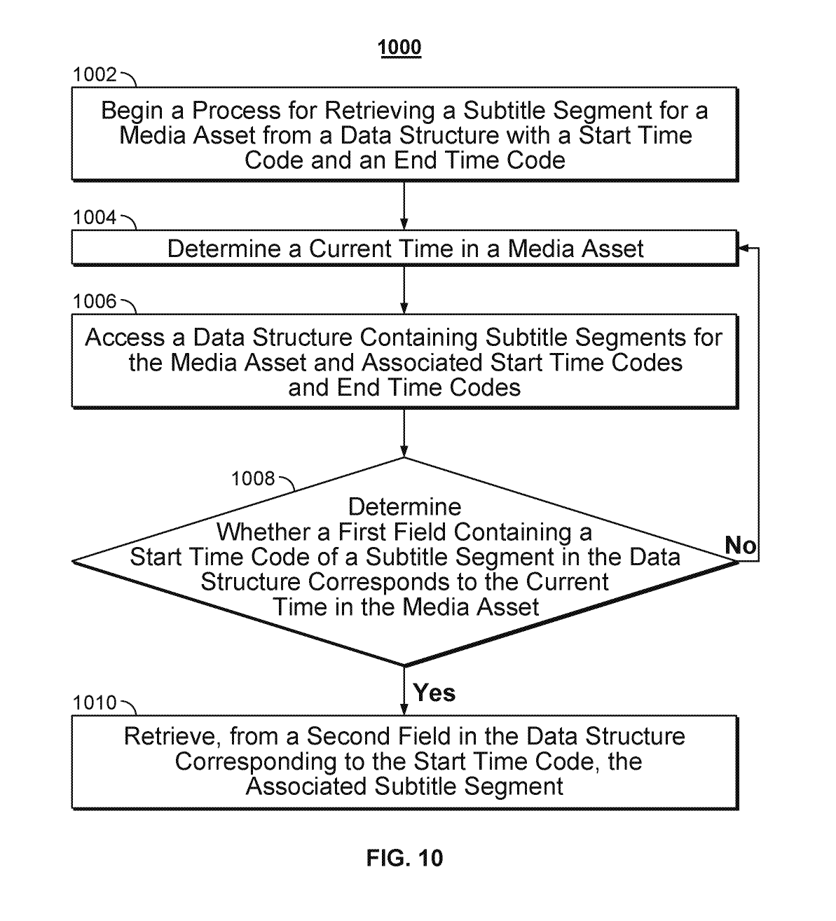

FIG. 3 includes table 300, which includes values for start time codes (e.g., start time codes 302 and 308), end time codes (e.g., end time code 304), and data 306 associated with subtitle segments. Data 306 may be a string of text characters that are stored in a field of the table, or data 306 may be a pointer to a location in memory containing text characters that correspond to the subtitle segment. The media guidance application may access table 300 in order to determine whether a subtitle segment should be retrieved and generated for display based on the current progress point in a media asset (e.g., as described further below with respect to FIG. 10). The media guidance application may also access table 300 to determine whether two subtitle segments would overlap if one was generated for display for an increased amount of time.

In some embodiments, the media guidance application may determine, based on comparing the new end time code of the subtitle segment with the start time codes associated with the subtitle segments stored in the subtitle data structure, whether any subtitle segments overlap. For example, the media guidance application may determine that a subtitle segment (e.g., with start time code 302 and end time code 304) should be increased by 10 seconds (e.g., past end time code 304) to allow a user to read the text of the segment. In order to determine whether the subtitle segment can be generated for display for 10 additional seconds, the media guidance application accesses table 300. The media guidance application then determines whether any start time codes (e.g., start time code 308) fall inside the range between the start and new end time code of the subtitle segment (e.g., between start time code 302 and 10 seconds after end time code 304). For example, the media guidance application may execute a database query language script (e.g., in SQL) utilizing a for-loop to iteratively retrieve and compare the start time codes and the new end time code. As described above with respect to FIG. 2, if the media guidance application determines no subtitle segments overlap, the media guidance application may generate the subtitle segment for the increased duration. If the media guidance application determines that a subtitle segment does overlap, the media guidance application analyzes the audiovisual characteristics of the media asset to determine which frames would obscure the action in the media asset the least if they were lengthened to allow the user more time to view the subtitle segment. In some embodiments, the media guidance application also generates, based on the data structure, a shifted data structure where the start and end time codes of subsequent subtitle segments are shifted by the amount of time the duration was increased to ensure subsequent subtitle segments are synchronized with the media asset. For example, if the length of the media asset is increased due to frames being generated for display for an increased amount of time, the media guidance application may generate a shifted data structure adding an offset to all subsequent time codes in the data structure (e.g., table 300). For example, if frames are inserted between start time code 302 and end time code 304 such that 20 seconds have been added, the media guidance application may add 20 seconds to all time codes after end time code 304 (e.g., start time code 308). This allows the media guidance application to ensure that subsequent subtitle segments are generated for display at appropriate times.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), on-demand information, blogs, websites, and any other type of guidance data that is helpful for a user to navigate among and locate desired content selections.

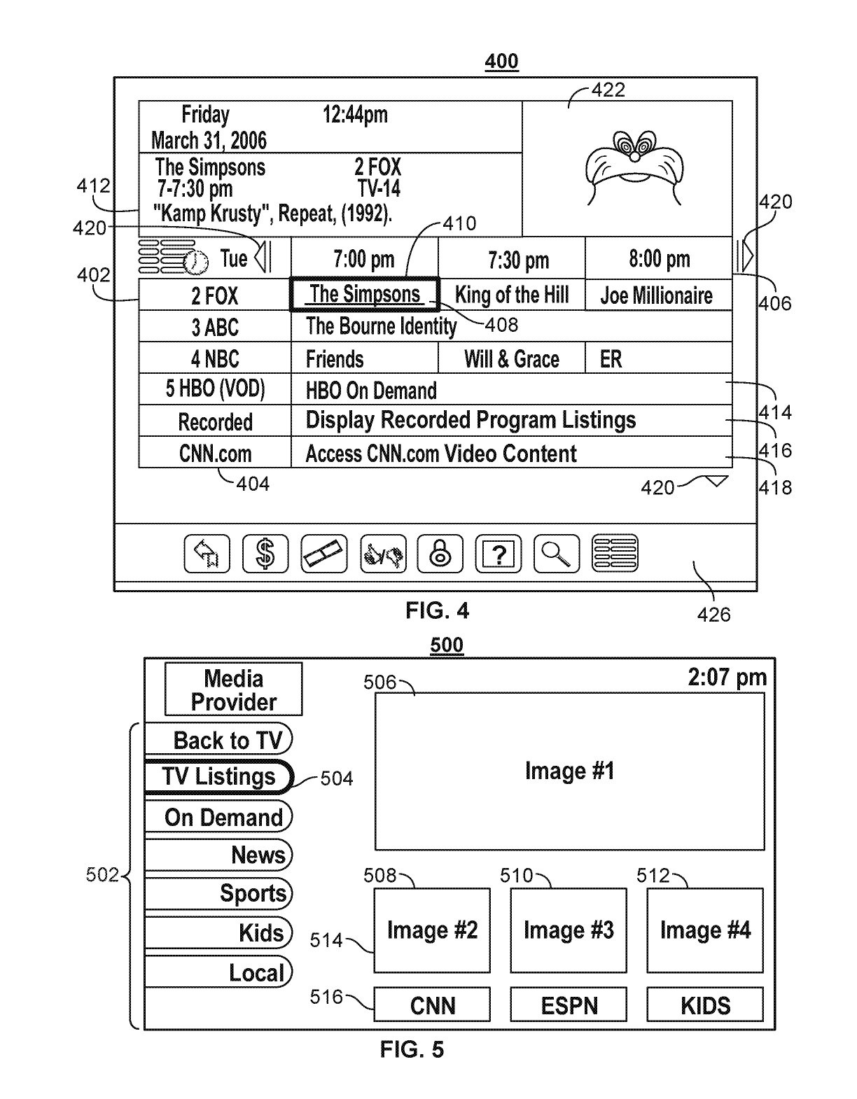

FIGS. 4-5 show illustrative display screens that may be used to provide media guidance data. The display screens shown in FIGS. 4-5 may be implemented on any suitable user equipment device or platform. While the displays of FIGS. 4-5 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 4 shows illustrative grid of a program listings display 400 arranged by time and channel that also enables access to different types of content in a single display. Display 400 may include grid 402 with: (1) a column of channel/content type identifiers 404, where each channel/content type identifier (which is a cell in the column) identifies a different channel or content type available; and (2) a row of time identifiers 406, where each time identifier (which is a cell in the row) identifies a time block of programming. Grid 402 also includes cells of program listings, such as program listing 408, where each listing provides the title of the program provided on the listing's associated channel and time. With a user input device, a user can select program listings by moving highlight region 410. Information relating to the program listing selected by highlight region 410 may be provided in program information region 412. Region 412 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 402 may provide media guidance data for non-linear programming including on-demand listing 414, recorded content listing 416, and Internet content listing 418. A display combining media guidance data for content from different types of content sources is sometimes referred to as a “mixed-media” display. Various permutations of the types of media guidance data that may be displayed that are different than display 400 may be based on user selection or guidance application definition (e.g., a display of only recorded and broadcast listings, only on-demand and broadcast listings, etc.). As illustrated, listings 414, 416, and 418 are shown as spanning the entire time block displayed in grid 402 to indicate that selection of these listings may provide access to a display dedicated to on-demand listings, recorded listings, or Internet listings, respectively. In some embodiments, listings for these content types may be included directly in grid 402. Additional media guidance data may be displayed in response to the user selecting one of the navigational icons 420. (Pressing an arrow key on a user input device may affect the display in a similar manner as selecting navigational icons 420.)

Display 400 may also include video region 422, and options region 426. Video region 422 may allow the user to view and/or preview programs that are currently available, will be available, or were available to the user. The content of video region 422 may correspond to, or be independent from, one of the listings displayed in grid 402. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Options region 426 may allow the user to access different types of content, media guidance application displays, and/or media guidance application features. Options region 426 may be part of display 400 (and other display screens described herein), or may be invoked by a user by selecting an on-screen option or pressing a dedicated or assignable button on a user input device. The selectable options within options region 426 may concern features related to program listings in grid 402 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.Tivo.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 7. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 5. Video mosaic display 500 includes selectable options 502 for content information organized based on content type, genre, and/or other organization criteria. In display 500, television listings option 504 is selected, thus providing listings 506, 508, 510, and 512 as broadcast program listings. In display 500 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 508 may include more than one portion, including media portion 514 and text portion 516. Media portion 514 and/or text portion 516 may be selectable to view content in full-screen or to view information related to the content displayed in media portion 514 (e.g., to view listings for the channel that the video is displayed on).

The listings in display 500 are of different sizes (i.e., listing 506 is larger than listings 508, 510, and 512), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

Users may access content and the media guidance application (and its display screens described above and below) from one or more of their user equipment devices. FIG. 6 shows a generalized embodiment of illustrative user equipment device 600. More specific implementations of user equipment devices are discussed below in connection with FIG. 7. User equipment device 600 may receive content and data via input/output (hereinafter “I/O”) path 602. I/O path 602 may provide content (e.g., broadcast programming, on-demand programming, Internet content, content available over a local area network (LAN) or wide area network (WAN), and/or other content) and data to control circuitry 604, which includes processing circuitry 606 and storage 608. Control circuitry 604 may be used to send and receive commands, requests, and other suitable data using I/O path 602. I/O path 602 may connect control circuitry 604 (and specifically processing circuitry 606) to one or more communications paths (described below). I/O functions may be provided by one or more of these communications paths, but are shown as a single path in FIG. 6 to avoid overcomplicating the drawing.

Control circuitry 604 may be based on any suitable processing circuitry such as processing circuitry 606. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 604 executes instructions for a media guidance application stored in memory (i.e., storage 608). Specifically, control circuitry 604 may be instructed by the media guidance application to perform the functions discussed above and below. For example, the media guidance application may provide instructions to control circuitry 604 to generate the media guidance displays. In some implementations, any action performed by control circuitry 604 may be based on instructions received from the media guidance application.

In client-server based embodiments, control circuitry 604 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 7). In addition, communications circuitry may include circuitry that enables peer-to-peer communication of user equipment devices, or communication of user equipment devices in locations remote from each other (described in more detail below).

Memory may be an electronic storage device provided as storage 608 that is part of control circuitry 604. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 608 may be used to store various types of content described herein as well as media guidance data described above. Nonvolatile memory may also be used (e.g., to launch a boot-up routine and other instructions). Cloud-based storage, described in relation to FIG. 7, may be used to supplement storage 608 or instead of storage 608.

Control circuitry 604 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 604 may also include scaler circuitry for upconverting and downconverting content into the preferred output format of the user equipment 600. Circuitry 604 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 608 is provided as a separate device from user equipment 600, the tuning and encoding circuitry (including multiple tuners) may be associated with storage 608.

A user may send instructions to control circuitry 604 using user input interface 610. User input interface 610 may be any suitable user interface, such as a remote control, mouse, trackball, keypad, keyboard, touch screen, touchpad, stylus input, joystick, voice recognition interface, or other user input interfaces. Display 612 may be provided as a stand-alone device or integrated with other elements of user equipment device 600. For example, display 612 may be a touchscreen or touch-sensitive display. In such circumstances, user input interface 610 may be integrated with or combined with display 612. Display 612 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 612 may be HDTV-capable. In some embodiments, display 612 may be a 3D display, and the interactive media guidance application and any suitable content may be displayed in 3D. A video card or graphics card may generate the output to the display 612. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 604. The video card may be integrated with the control circuitry 604. Speakers 614 may be provided as integrated with other elements of user equipment device 600 or may be stand-alone units. The audio component of videos and other content displayed on display 612 may be played through speakers 614. In some embodiments, the audio may be distributed to a receiver (not shown), which processes and outputs the audio via speakers 614.

The guidance application may be implemented using any suitable architecture. For example, it may be a stand-alone application wholly-implemented on user equipment device 600. In such an approach, instructions of the application are stored locally (e.g., in storage 608), and data for use by the application is downloaded on a periodic basis (e.g., from an out-of-band feed, from an Internet resource, or using another suitable approach). Control circuitry 604 may retrieve instructions of the application from storage 608 and process the instructions to generate any of the displays discussed herein. Based on the processed instructions, control circuitry 604 may determine what action to perform when input is received from input interface 610. For example, movement of a cursor on a display up/down may be indicated by the processed instructions when input interface 610 indicates that an up/down button was selected.

In some embodiments, the media guidance application is a client-server based application. Data for use by a thick or thin client implemented on user equipment device 600 is retrieved on-demand by issuing requests to a server remote to the user equipment device 600. In one example of a client-server based guidance application, control circuitry 604 runs a web browser that interprets web pages provided by a remote server. For example, the remote server may store the instructions for the application in a storage device. The remote server may process the stored instructions using circuitry (e.g., control circuitry 604) and generate the displays discussed above and below. The client device may receive the displays generated by the remote server and may display the content of the displays locally on equipment device 600. This way, the processing of the instructions is performed remotely by the server while the resulting displays are provided locally on equipment device 600. Equipment device 600 may receive inputs from the user via input interface 610 and transmit those inputs to the remote server for processing and generating the corresponding displays. For example, equipment device 600 may transmit a communication to the remote server indicating that an up/down button was selected via input interface 610. The remote server may process instructions in accordance with that input and generate a display of the application corresponding to the input (e.g., a display that moves a cursor up/down). The generated display is then transmitted to equipment device 600 for presentation to the user.

In some embodiments, the media guidance application is downloaded and interpreted or otherwise run by an interpreter or virtual machine (run by control circuitry 604). In some embodiments, the guidance application may be encoded in the ETV Binary Interchange Format (EBIF), received by control circuitry 604 as part of a suitable feed, and interpreted by a user agent running on control circuitry 604. For example, the guidance application may be an EBIF application. In some embodiments, the guidance application may be defined by a series of JAVA-based files that are received and run by a local virtual machine or other suitable middleware executed by control circuitry 604. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 600 of FIG. 6 can be implemented in system 700 of FIG. 7 as user television equipment 702, user computer equipment 704, wireless user communications device 706, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 6 may not be classified solely as user television equipment 702, user computer equipment 704, or a wireless user communications device 706. For example, user television equipment 702 may, like some user computer equipment 704, be Internet-enabled allowing for access to Internet content, while user computer equipment 704 may, like some television equipment 702, include a tuner allowing for access to television programming. The media guidance application may have the same layout on various different types of user equipment or may be tailored to the display capabilities of the user equipment. For example, on user computer equipment 704, the guidance application may be provided as a web site accessed by a web browser. In another example, the guidance application may be scaled down for wireless user communications devices 706.

In system 700, there is typically more than one of each type of user equipment device but only one of each is shown in FIG. 7 to avoid overcomplicating the drawing. In addition, each user may utilize more than one type of user equipment device and also more than one of each type of user equipment device.

In some embodiments, a user equipment device (e.g., user television equipment 702, user computer equipment 704, wireless user communications device 706) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.Tivo.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 714. Namely, user television equipment 702, user computer equipment 704, and wireless user communications device 706 are coupled to communications network 714 via communications paths 708, 710, and 712, respectively. Communications network 714 may be one or more networks including the Internet, a mobile phone network, mobile voice or data network (e.g., a 4G or LTE network), cable network, public switched telephone network, or other types of communications network or combinations of communications networks. Paths 708, 710, and 712 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 712 is drawn with dotted lines to indicate that in the exemplary embodiment shown in FIG. 7 it is a wireless path and paths 708 and 710 are drawn as solid lines to indicate they are wired paths (although these paths may be wireless paths, if desired). Communications with the user equipment devices may be provided by one or more of these communications paths, but are shown as a single path in FIG. 7 to avoid overcomplicating the drawing.

Although communications paths are not drawn between user equipment devices, these devices may communicate directly with each other via communication paths, such as those described above in connection with paths 708, 710, and 712, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 714.

System 700 includes content source 716 and media guidance data source 718 coupled to communications network 714 via communication paths 720 and 722, respectively. Paths 720 and 722 may include any of the communication paths described above in connection with paths 708, 710, and 712. Communications with the content source 716 and media guidance data source 718 may be exchanged over one or more communications paths, but are shown as a single path in FIG. 7 to avoid overcomplicating the drawing. In addition, there may be more than one of each of content source 716 and media guidance data source 718, but only one of each is shown in FIG. 7 to avoid overcomplicating the drawing. (The different types of each of these sources are discussed below.) If desired, content source 716 and media guidance data source 718 may be integrated as one source device. Although communications between sources 716 and 718 with user equipment devices 702, 704, and 706 are shown as through communications network 714, in some embodiments, sources 716 and 718 may communicate directly with user equipment devices 702, 704, and 706 via communication paths (not shown) such as those described above in connection with paths 708, 710, and 712.

Content source 716 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 716 may be the originator of content (e.g., a television broadcaster, a Webcast provider, etc.) or may not be the originator of content (e.g., an on-demand content provider, an Internet provider of content of broadcast programs for downloading, etc.). Content source 716 may include cable sources, satellite providers, on-demand providers, Internet providers, over-the-top content providers, or other providers of content. Content source 716 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 718 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 718 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 718 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 718 may provide user equipment devices 702, 704, and 706 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 608, and executed by control circuitry 604 of a user equipment device 600. In some embodiments, media guidance applications may be client-server applications where only a client application resides on the user equipment device, and server application resides on a remote server. For example, media guidance applications may be implemented partially as a client application on control circuitry 604 of user equipment device 600 and partially on a remote server as a server application (e.g., media guidance data source 718) running on control circuitry of the remote server. When executed by control circuitry of the remote server (such as media guidance data source 718), the media guidance application may instruct the control circuitry to generate the guidance application displays and transmit the generated displays to the user equipment devices. The server application may instruct the control circuitry of the media guidance data source 718 to transmit data for storage on the user equipment. The client application may instruct control circuitry of the receiving user equipment to generate the guidance application displays.

Content and/or media guidance data delivered to user equipment devices 702, 704, and 706 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 700 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 7.

In one approach, user equipment devices may communicate with each other within a home network. User equipment devices can communicate with each other directly via short-range point-to-point communication schemes described above, via indirect paths through a hub or other similar device provided on a home network, or via communications network 714. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 716 to access content. Specifically, within a home, users of user television equipment 702 and user computer equipment 704 may access the media guidance application to navigate among and locate desirable content. Users may also access the media guidance application outside of the home using wireless user communications devices 706 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 714. These cloud resources may include one or more content sources 716 and one or more media guidance data sources 718. In addition or in the alternative, the remote computing sites may include other user equipment devices, such as user television equipment 702, user computer equipment 704, and wireless user communications device 706. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 704 or wireless user communications device 706 having content capture feature. Alternatively, the user can first transfer the content to a user equipment device, such as user computer equipment 704. The user equipment device storing the content uploads the content to the cloud using a data transmission service on communications network 714. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 6.

As referred herein, the term “in response to” refers to initiated as a result of. For example, a first action being performed in response to a second action may include interstitial steps between the first action and the second action. As referred herein, the term “directly in response to” refers to caused by. For example, a first action being performed directly in response to a second action may not include interstitial steps between the first action and the second action.

FIG. 8 is a flowchart of illustrative steps for adjusting lengths of time subtitle segments are displayed, in accordance with some embodiments of the disclosure. For example, a media guidance application implementing process 800 may be executed by control circuitry 604 (FIG. 6). It should be noted that process 800 or any step thereof could be performed on, or provided by, any of the devices shown in FIGS. 6-7.

Process 800 begins at 802, where the media guidance application determines (e.g., via control circuitry 604 (FIG. 6)) a rate that a user reads words. For example, the media guidance application may access a user profile (e.g., stored locally in storage 608 (FIG. 6), or remotely at media guidance data source 718 accessible via communications network 714 (FIG. 7)) containing a value for the rate at which a user reads words. The value may be expressed in words per any unit of time (e.g., seconds, minutes, etc.) and may be converted in order to be compared to other rates. For example, if a rate is not already stored for a given user, the media guidance application may execute (e.g., via control circuitry 604 (FIG. 6)) a calibration module that generates for display (e.g., on display 612 (FIG. 6)) text and prompts a user to select a button (e.g., on a remote control) when they are finished reading the text to determine the rate at which the user reads (e.g., as described above with respect to FIG. 1).

Process 800 continues to 804, where the media guidance application accesses (e.g., via control circuitry 604 (FIG. 6)) a subtitle data structure for the media asset containing start time codes and end time codes associated with subtitle segments. For example, the media guidance application may receive a user input (e.g., via user input interface 610 (FIG. 6)) selecting a media asset (e.g., a movie) for viewing with subtitles on. The media guidance application may determine the identity of the user before (e.g., via a login screen to a user account) or after (e.g., based on facial recognition software and a camera identifying the user near a screen that is generating for display the media asset) selection of the media asset.

Process 800 continues to 806, where the media guidance application retrieves (e.g., via control circuitry 604 (FIG. 6)) a subtitle segment from the data structure with a start time code and an end time code. For example, as described above with respect to FIG. 3, the data structure (e.g., stored locally in storage 608 (FIG. 6), or remotely at media guidance data source 718 accessible via communications network 714 (FIG. 7)) may be organized as a table where each row contains time codes (e.g., in hours:minutes:seconds:frames) corresponding to the first and last frame where the subtitle text is to be generated for display (e.g., on display 612 (FIG. 6)), as well as a field with a string containing the text. Alternatively, the field may contain a pointer to a location in memory storing the string containing the text. In some embodiments, the subtitle data is obtained in real-time, or with a small buffer delay, in data packets from a media content source (e.g., media content source 716). In this situation, a data packet may only contain indications of when to display or cease displaying a single subtitle segment and the associated text (e.g., a string of characters), as opposed to a table where every subtitle segment has been mapped to time codes already.

Process 800 continues to 808, where the media guidance application determines (e.g., via control circuitry 604 (FIG. 6)) a number of words in the subtitle segment. For example, the media guidance application may determine a word based on white space detection between consecutive characters for a given string of characters. For example, in a subtitle segment with text “I am your father,” the media guidance application may determine there are four words based on the three white spaces between characters.

Process 800 continues to 810, where the media guidance application determines (e.g., via control circuitry 604 (FIG. 6)) a duration by subtracting the start time code from the end time code. For example, if the start time code is 00:11:10:05 and the end time code is 00:12:10:05, the media guidance application may determine that the duration the subtitle segment will be generated for display is one minute.

Process 800 continues to 812, where the media guidance application calculates (e.g., via control circuitry 604 (FIG. 6)) a displayed word rate for the subtitle segment by dividing the number of words by the duration. For example, if the number of words is five and the total duration is one minute, then the displayed word rate is five words per minute.

Process 800 continues to 814, where the media guidance application determines (e.g., via control circuitry 604 (FIG. 6)) whether the rate that the user reads words is less than the displayed word rate for the subtitle segment. For example, the rate that the user reads words determined based on the calibration may be retrieved by the media guidance application from a user profile for the user. The media guidance application may then compare the rate that the user reads words (e.g., 20 words per minute) to the displayed word rate for the subtitle segment (e.g., 25 words per minute) to determine whether the user is able to read the words in the subtitle segment before they are no longer generated for display (e.g., on display 612 (FIG. 6)).

If, at step 814, the media guidance application determines that the rate that the user reads words is not less than the displayed word rate for the subtitle segment, process 800 continues to 816 where the media guidance application does not increase (e.g., via control circuitry 604 (FIG. 6)) the duration that the subtitle segment is generated for display. For example, if the rate that the user reads words is greater than the displayed word rate, the media guidance application may determine that the user has enough time to read the text of the subtitle segment without adjustment to the length the subtitle segment is generated for display (e.g., on display 612 (FIG. 6)). Process 800 then continues to 818, where the media guidance application generates (e.g., via control circuitry 604 (FIG. 6)) the subtitle segment for display for the duration. For example, since no adjustment to the length of time the subtitle segment is generated for display is needed, the media guidance application may generate the subtitle segment for display for the original duration (e.g., as indicated in the subtitle data structure).

If, at step 814, the media guidance application determines that the rate that the user reads words is less than the displayed word rate for the subtitle segment, process 800 continues to 820 where the media guidance application increases (e.g., via control circuitry 604 (FIG. 6)) the duration that the subtitle segment is generated for display. For example, the media guidance application may extend the length of time the subtitle segment is generated for display by displaying the subtitle segment past the end time code. Process 800 continues to 822, where the media guidance application generates (e.g., via control circuitry 604 (FIG. 6)) the subtitle segment for display for the increased duration.

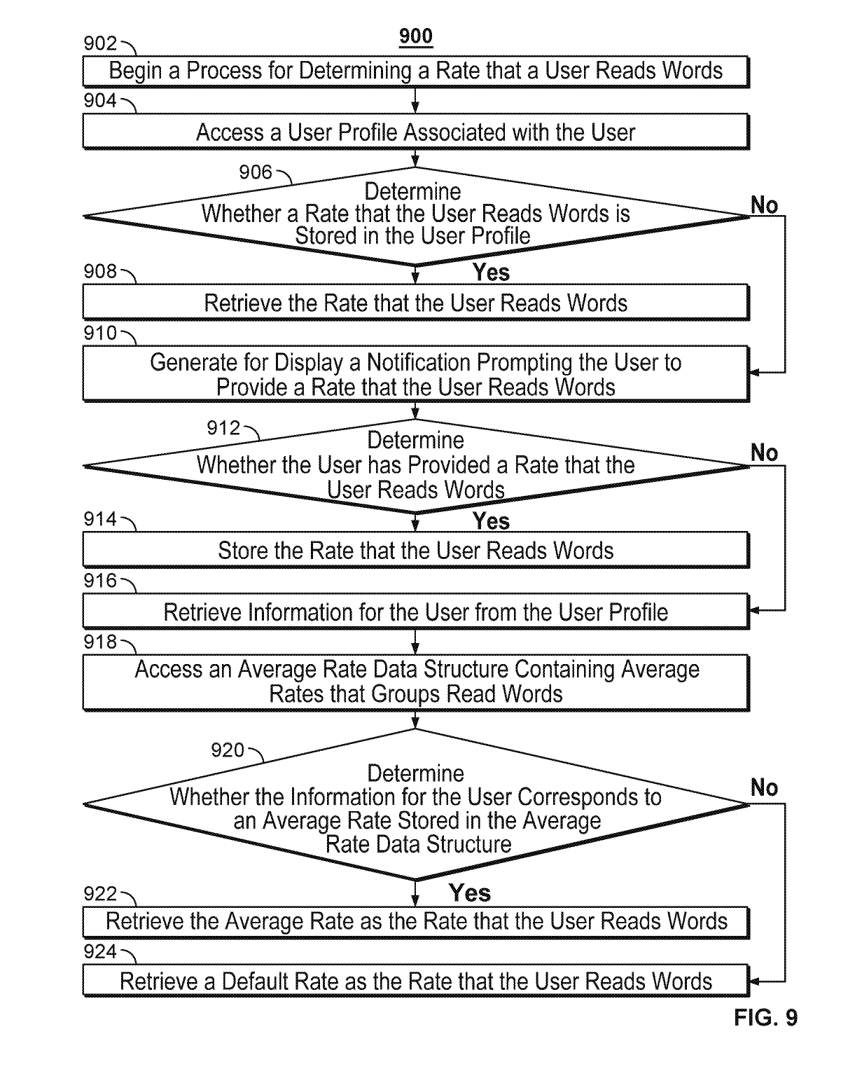

FIG. 9 is a flowchart of illustrative steps for determining a rate that a user reads words, in accordance with some embodiments of the disclosure. For example, a media guidance application implementing process 900 may be executed by control circuitry 604 (FIG. 6). It should be noted that process 900 or any step thereof could be performed on, or provided by, any of the devices shown in FIGS. 6-7. Process 900 starts at 902, where the media guidance application begins (e.g., via control circuitry 604 (FIG. 6)) a process for determining a rate that a user reads words. For example, the media guidance application may initialize the necessary variables and execute (e.g., via control circuitry 604 (FIG. 6)) a program script calling a particular method to execute process 900.

Process 900 continues to 904, where the media guidance application accesses (e.g., via control circuitry 604 (FIG. 6)) a user profile associated with the user. For example, the media guidance application may access the user profile locally (e.g., in storage 608 (FIG. 6)), or remotely at a server (e.g., media guidance data source 718 accessible via communications network 714 (FIG. 7)).

Process 900 continues to 906, where the media guidance application determines (e.g., via control circuitry 604 (FIG. 6)) whether a rate that the user reads words is stored in the user profile. For example, the media guidance application may execute a program script in a database query language such as SQL to retrieve data from fields in the user profile. Based on the retrieved data, the media guidance application determines whether the rate that the user reads words is stored in the user profile (e.g., based on a flag set to “true”).

If at step 906 the media guidance application determines that a rate that the user reads words is stored in the user profile, process 900 continues to 908, where the media guidance application retrieves (e.g., via control circuitry 604 (FIG. 6)) the rate that the user reads words. For example, the media guidance application may execute a program script to retrieve a value for the rate that the user reads words from the user profile to use when determining whether the displayed word rate is greater than the rate that the user reads words.

If at step 906 the media guidance application determines that a rate that the user reads words is not stored in the user profile, process 900 continues to 910, where the media guidance application generates (e.g., via control circuitry 604 (FIG. 6)) for display a notification prompting the user to provide a rate that the user reads words. For example, the media guidance application may generate for display (e.g., on display 612 (FIG. 6)) text informing the user that the rate that the user reads words is not known. The media guidance application may additionally generate for display selectable options for the user to input the rate (e.g., via user input interface 610 (FIG. 6)), open a calibration module (e.g., as described above) to determine the rate that the user reads words, or to close the notification.

Process 900 continues to 912, where the media guidance application determines (e.g., via control circuitry 604 (FIG. 6)) whether the user has provided a rate that the user reads words. For example, the media guidance application determines, based on the user's response to the notification, whether a rate that the user receives words has now been received (e.g., a numerical value). For example, the media guidance application may receive input of the rate that the user reads words from the user (e.g., via user input interface 610 (FIG. 6)).

If the media guidance application determines that the user has provided a rate that the user reads words, process 900 continues to 914 where the media guidance application stores (e.g., via control circuitry 604 (FIG. 6)) the rate that the user reads words. For example, the media guidance application may access the user profile and store the rate so it can be used in the future for the user when determining an appropriate length for subtitle segments.

If the media guidance application determines that the user has not provided a rate that the user reads words, process 900 continues to 916 where the media guidance application retrieves (e.g., via control circuitry 604 (FIG. 6)) information for the user from the user profile. For example, the media guidance application may retrieve any data, such as demographic information, education, viewing history, etc. stored in the user profile that can be used to determine an estimate for the rate that the user reads words.

Process 900 continues to 918, where the media guidance application accesses (e.g., via control circuitry 604 (FIG. 6)) an average rate data structure containing average rates that groups read words. For example, the average rate data structure may be stored locally (e.g., in storage 608 (FIG. 6)), or remotely at a server (e.g., media guidance data source 718 accessible via communications network 714 (FIG. 7)). The average rate data structure may be organized as a table, where each row contains fields with characteristics (e.g., education), a value (e.g., PhD) and an average rate that users with that characteristic and value read words (e.g., 50 words per minute).

Process 900 continues to 920, where the media guidance application determines (e.g., via control circuitry 604 (FIG. 6)) whether the information for the user corresponds to an average rate stored in the average rate data structure. For example, the media guidance application may determine, based on the information from the user profile, that the user corresponds to a group. For example, the media guidance application may retrieve that the user received a PhD and based on comparing the retrieved value with the database, determine that the average rate users who have a PhD read words applies to the user.

If at step 920 the media guidance application determines that an average rate stored in the average rate data structure applies to the user, process 900 continues to 922, where the media guidance application retrieves (e.g., via control circuitry 604 (FIG. 6)) the average rate as the rate that the user reads words. For example, the media guidance application may retrieve the value “50” from a field in the average rate data structure corresponding to 50 words per minute and store this value as the rate that the user reads words. Alternatively or additionally, the media guidance application may match multiple characteristics in the average rate data structure to information from the user profile and average the associated average rates.

If at step 920 the media guidance application determines that no average rate stored in the average rate data structure applies to the user, process 900 continues to 924, where the media guidance application retrieves (e.g., via control circuitry 604 (FIG. 6)) a default rate as the rate that the user reads words. For example, the media guidance application may retrieve the value “25” from a field in the average rate data structure corresponding to the default value for users who do not correspond to a group. The media guidance application may then store this value as the rate that the user reads words.

FIG. 10 is a flowchart of illustrative steps for retrieving a subtitle segment for a media asset from a data structure, in accordance with some embodiments of the disclosure. For example, a media guidance application implementing process 1000 may be executed by control circuitry 604 (FIG. 6). It should be noted that process 1000 or any step thereof could be performed on, or provided by, any of the devices shown in FIGS. 6-7. Process 1000 starts at 1002, where the media guidance application begins (e.g., via control circuitry 604 (FIG. 6)) a process for retrieving a subtitle segment for a media asset from a data structure with a start time code and an end time code. For example, the media guidance application may initialize the necessary variables and execute (e.g., via control circuitry 604 (FIG. 6)) a program script calling a particular method to execute process 1000.

Process 1000 continues to 1004, where the media guidance application determines (e.g., via control circuitry 604 (FIG. 6)) a current time in a media asset. For example, the media guidance application may determine the current playback point (e.g., a time code in the same format as the start and end time codes discussed above with respect to FIGS. 1-3) in the media asset being generated for display (e.g., on display 612 (FIG. 6)) for the user.

Process 1000 continues to 1006, where the media guidance application accesses (e.g., via control circuitry 604 (FIG. 6)) a data structure containing subtitle segments for the media asset and associated start time codes and end time codes. For example, the media guidance application may access the data structure locally (e.g., in storage 608 (FIG. 6)), or remotely at a server (e.g., media guidance data source 718 accessible via communications network 714 (FIG. 7)). In some embodiments, the data structure may be organized as a table in the same manner as table 300 described above with respect to FIG. 3.

Process 1000 continues to 1008, where the media guidance application determines (e.g., via control circuitry 604 (FIG. 6)) whether a first field containing a start time code of a subtitle segment in the data structure corresponds to the current time in the media asset. For example, the media guidance application may execute a program script utilizing a for-loop to iteratively compare start time codes in the data structure with the playback point in the media asset. For example, the media guidance application may compare a current time indicating that the media asset has been generated for display for 2 minutes with entries in the data structure to see if any start time codes contain a value corresponding to 2 minutes.

If, at step 1008, the media guidance application determines that a start time code corresponds to the current time, process 1000 continues to 1010, where the media guidance application retrieves (e.g., via control circuitry 604 (FIG. 6)) from a second field in the data structure corresponding to the start time code, the associated subtitle segment. For example, the media guidance application may retrieve from the second field a string containing the text. Alternatively, the field may contain a pointer to a location in memory (e.g., storage 608 (FIG. 6)) storing the string containing the text.

If, at step 1008, the media guidance application does not determines a start time code that corresponds to the current time, process 1000 returns to 1004, where the media guidance application determines (e.g., via control circuitry 604 (FIG. 6)) a current time in a media asset. For example, the media guidance application may continue to monitor the playback point in the media asset and compare the current time in the media asset to start time codes in the data structure.

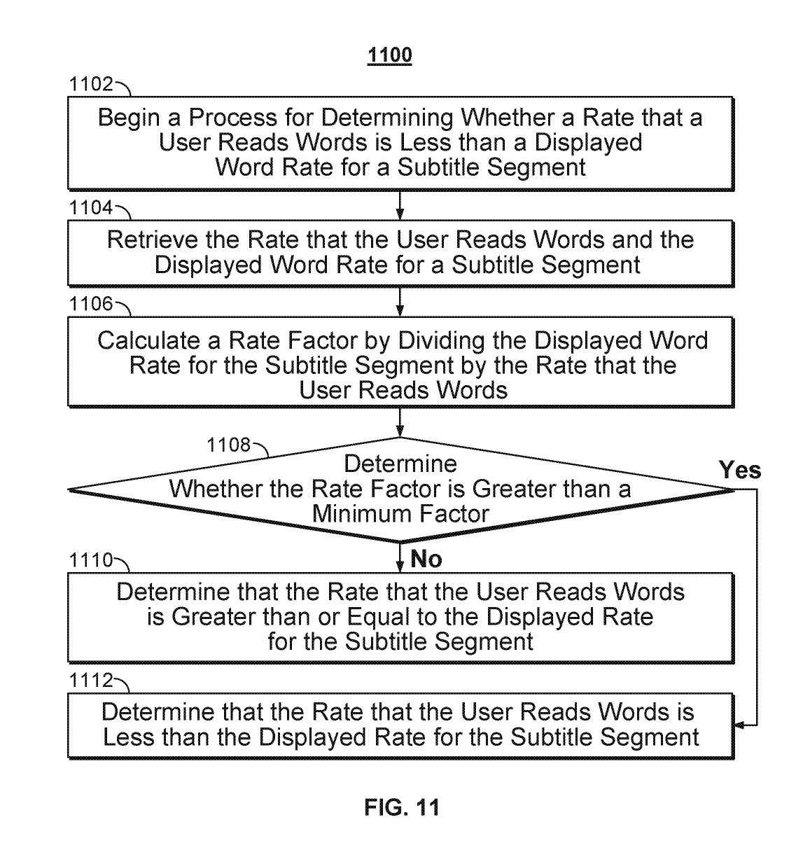

FIG. 11 is a flowchart of illustrative steps for determining whether a rate that a user reads words is less than a displayed word rate for a subtitle segment, in accordance with some embodiments of the disclosure. For example, a media guidance application implementing process 1100 may be executed by control circuitry 604 (FIG. 6). It should be noted that process 1100 or any step thereof could be performed on, or provided by, any of the devices shown in FIGS. 6-7. Process 1100 starts at 1102, where the media guidance application begins (e.g., via control circuitry 604 (FIG. 6)) a process for determining whether a rate that a user reads words is less than a displayed word rate for a subtitle segment. For example, the media guidance application may initialize the necessary variables and execute (e.g., via control circuitry 604 (FIG. 6)) a program script calling a particular method to execute process 1100.

Process 1100 continues to 1104, where the media guidance application retrieves (e.g., via control circuitry 604 (FIG. 6)) the rate that the user reads words and the displayed word rate for a subtitle segment. For example, the media guidance application may retrieve the rate that the user reads words from a field in a user profile, which may be stored locally (e.g., in storage 608 (FIG. 6)), or remotely at a server (e.g., media guidance data source 718 accessible via communications network 714 (FIG. 7)). For example, the media guidance application may retrieve the displayed word rate for a subtitle segment from a field in the data structure the subtitle segment was retrieved from. Alternatively or additionally, the media guidance application may calculate the displayed word rate based on the text of the subtitle segment and the start and end time codes, as described above.

Process 1100 continues to 1106, where the media guidance application calculates (e.g., via control circuitry 604 (FIG. 6)) a rate factor by dividing the displayed word rate for the subtitle segment by the rate that the user reads words. For example, the media guidance application may calculate the rate factor to quantify how different the rate that the user reads words is from the displayed word rate. For example, the media guidance application may calculate a factor of 1.1 if the rate that the user reads words is 10 words per minute and the displayed word rate is 11 words per minute.

Process 1100 continues to 1108, where the media guidance application determines (e.g., via control circuitry 604 (FIG. 6)) whether the rate factor is greater than a minimum factor. For example, the media guidance application may compare the rate factor to the minimum factor to determine whether the rates are sufficiently close and no adjustment to the duration is necessary (e.g., if the factor is 1.0001).

If at step 1108, the media guidance application determines that the rate factor is not greater than the minimum factor, process 1100 continues to 1110, where the media guidance application determines (e.g., via control circuitry 604 (FIG. 6)) that the rate that the user reads words is greater than or equal to the displayed rate for the subtitle segment. For example, based on determining that the rate that the user reads words is greater than or equal to the displayed word rate, the media guidance application may determine that the duration that the subtitle segment is generated for display (e.g., on display 612 (FIG. 6)) does not need to be increased.

If at step 1108, the media guidance application determines that the rate factor is greater than the minimum factor, process 1100 continues to 1112, where the media guidance application determines (e.g., via control circuitry 604 (FIG. 6)) that the rate that the user reads words is less than the displayed rate for the subtitle segment. For example, based on determining that the rate that the user reads words is greater than the minimum factor, the media guidance application may determine that the duration the subtitle segment is generated for display (e.g., on display 612 (FIG. 6)) needs to be increased to give the user enough time to fully read the text of the subtitle segment.

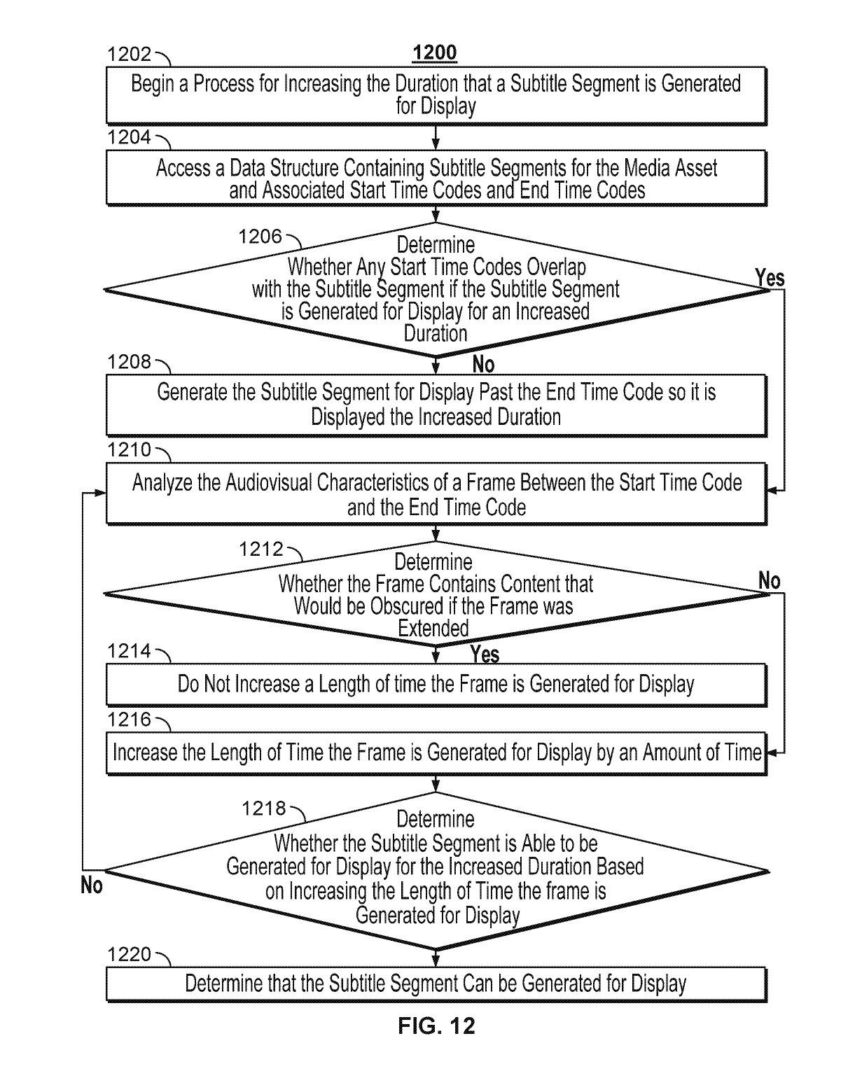

FIG. 12 is a flowchart of illustrative steps for increasing the duration that a subtitle segment is generated for display, in accordance with some embodiments of the disclosure. For example, a media guidance application implementing process 1200 may be executed by control circuitry 604 (FIG. 6). It should be noted that process 1200 or any step thereof could be performed on, or provided by, any of the devices shown in FIGS. 6-7. Process 1200 starts at 1202, where the media guidance application begins (e.g., via control circuitry 604 (FIG. 6)) a process for increasing the duration that a subtitle segment is generated for display. For example, the media guidance application may initialize the necessary variables and execute (e.g., via control circuitry 604 (FIG. 6)) a program script calling a particular method to execute process 1200.

Process 1200 continues to 1204, where the media guidance application accesses (e.g., via control circuitry 604 (FIG. 6)) a data structure containing subtitle segments for the media asset and associated start time codes and end time codes. For example, the media guidance application may access the data structure locally (e.g., in storage 608 (FIG. 6)), or remotely at a server (e.g., media guidance data source 718 accessible via communications network 714 (FIG. 7)). In some embodiments, the data structure may be organized as a table in the same manner as table 300 described above with respect to FIG. 3.

Process 1200 continues to 1206, where the media guidance application determines (e.g., via control circuitry 604 (FIG. 6)) whether any start time codes overlap with the subtitle segment if the subtitle segment is generated for display for an increased duration. For example, as described above with respect to FIGS. 2-3, the media guidance application may compare the start time codes in the data structure to the new end time code that corresponds to the increased duration the subtitle segment is generated for display (e.g., on display 612 (FIG. 6)).

If the media guidance application determines that no start time codes overlap with the subtitle segment generated for display for the increased duration, process 1200 continues to 1208, where the media guidance application generates (e.g., via control circuitry 604 (FIG. 6)) the subtitle segment for display past the end time code so it is displayed the increased duration. For example, if there are no start time codes in the subtitle data structure that overlap with the new end time code, the media guidance application may increase the time that the subtitle segment is generated for display (e.g., display the subtitle segment until the new end time code).

If the media guidance application determines that a start time codes does overlap with the subtitle segment generated for display for the increased duration, process 1200 continues to 1210, where the media guidance application analyzes (e.g., via control circuitry 604 (FIG. 6)) the audiovisual characteristics of a frame between the start time code and the end time code. For example, as described above with respect to FIG. 2, the media guidance application may extract frames from the media asset between the start time code and the end time code and analyze the audio properties (e.g., frequency and amplitude at specific frames) as well as the visual properties (e.g., based on a pixel map) of the frames.

Process 1200 continues to 1212, where the media guidance application determines (e.g., via control circuitry 604 (FIG. 6)) whether the frame contains content that would be obscured if the frame was extended. For example, as described above with respect to FIG. 2, the media guidance application may analyze the audio and the visual components of frames between the start time code and the end time code to determine frames that contain minimal action and/or human speech and thus would not obscure the action in the media asset (e.g., because the frames correspond to a still shot of a landscape).

If at step 1212 the media guidance application determines that the frame obscures the content of the media asset if it was extended, process 1200 continues to 1214, where the media guidance application does not increase (e.g., via control circuitry 604 (FIG. 6)) a length of time the frame is generated for display. For example, the media guidance application, upon determining that a particular frame contains content that would obscured (e.g., if a person is speaking at that frame their voice might be changed when the frame is lengthened in a way that is perceptible to the user), the media guidance application does not increase the time the particular frame is generated for display (e.g., on display 612 (FIG. 6)).

If at step 1212 the media guidance application determines that the frame does not obscure the content of the media asset if it was extended, process 1200 continues to 1216, where the media guidance application increases (e.g., via control circuitry 604 (FIG. 6)) the length of time the frame is generated for display by an amount of time. For example, as discussed above with respect to FIGS. 1-3, the media guidance application may determine that playback can be slowed down during the frame or additional frames can be inserted to allow the user more time to read the subtitle segment. The media guidance application may store a list identifying frames that have been identified where an increase in the time the frame is generated for display would not obscure the media asset. When a new frame is determined to not obscure content of the media asset if extended, the media guidance application may write an identifier of the frame to the list, as well as the amount of time that the frame is lengthened.

After determining whether to increase the length of time the frame is generated for display at steps 1214 and 1216, process 1200 continues to 1218, where the media guidance application determines (e.g., via control circuitry 604 (FIG. 6)) whether the subtitle segment is able to be generated for display for the increased duration based on increasing the length of time the frame is generated for display. For example, as described above with respect to FIG. 1-3, a new end time code representing a point in the playback of the media asset after the end time code in the data structure that allows the user enough time to read the text of the subtitle segment can be calculated based on the rate that the user reads words. For example, the media guidance application may track (e.g., on a list as described above with respect to step 1216) the frames that can be lengthened. The media guidance application may then compare, based on the number of frames on the list and the amount of time each frame will be lengthened, the length the subtitle segment will be displayed to the new end time code to determine whether enough frames have been tagged to be lengthened when generating the media asset for display (e.g., on display 612 (FIG. 6)).

If the media guidance application determines that the subtitle segment is able to be generated for display for the increased length of time, process 1200 continues to 1220, where the media guidance application determines (e.g., via control circuitry 604 (FIG. 6)) that the subtitle segment can be generated for display. For example, based on the frame(s) already on the list of frames to have their playback lengthened during display of the media asset, the subtitle segment can be generated for display by the media guidance application for the increased duration that allows the user enough time to read the subtitle segment.

If the media guidance application determines that the subtitle segment is not able to be generated for display for the increased length of time, process 1200 returns to 1210, where the media guidance application analyzes (e.g., via control circuitry 604 (FIG. 6)) the audiovisual characteristics of another frame between the start time code and the end time code. For example, until the subtitle segment can be generated for display for the increased duration (e.g., enough frames that do not obscure the media asset have been identified), the media guidance application continues to search for more frames to extend playback of.

It is contemplated that the steps or descriptions of each of FIGS. 8-12 may be used with any other embodiment of this disclosure. In addition, the steps and descriptions described in relation to FIGS. 8-12 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 6-7 could be used to perform one or more of the steps in FIGS. 8-12.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. (canceled)

2. A method for adjusting lengths of time subtitle segments are displayed, the method comprising:
determining a rate that a user reads words;
retrieving a subtitle segment from a subtitle data structure for a media asset, the subtitle segment associated with a start time code and an end time code;
calculating a displayed word rate for the subtitle segment;
determining whether the rate that the user reads words is less than the displayed word rate for the subtitle segment by calculating a rate factor by dividing the displayed word rate for the subtitle segment by the rate that the user reads words;
comparing the rate factor to a minimum factor and a maximum factor;
in response to determining that the rate factor is greater than the minimum factor and that the rate factor is less than the maximum factor:
determining that the rate that the user reads words is less than the displayed word rate for the subtitle segment,
determining an increased duration to display the subtitle segment by multiplying the duration of the subtitle segment by the rate factor, wherein the increased duration ends at a new end time code, and
generating the subtitle segment for display for the increased duration;
in response to determining that the rate factor is greater than the minimum factor and that the rate factor is greater than the maximum factor, determining that the rate that the user reads words is less than the displayed word rate for the subtitle segment and that the duration of the subtitle segment cannot be adjusted by the rate factor.

3. The method of claim 2, wherein determining the rate that the user reads words comprises:
accessing a calibration data structure;
retrieving a calibration text passage and a value for a number of words in the calibration text passage from the calibration data structure;
in response to receiving a first user input to determine the rate that the user reads words:
generating for display the calibration text passage; and
determining an initial time at which the calibration text passage was first generated for display;
in response to receiving a second user input that the user has finished reading the calibration text passage, determining an end time;
calculating a calibration duration by subtracting the initial time from the end time; and
calculating the rate that the user reads words by dividing the number of words in the calibration text passage by the calibration duration.

4. The method of claim 2, wherein determining the rate that the user reads words comprises:
determining, from an indication in a user profile for the user, a first time that the user opened textual content on a mobile device;
determining a second time that the user closed the textual content after opening the textual content;
determining a number of words in the textual content; and
calculating, based on the difference between the first time and the second time and the number of words in the textual content, the rate that the user reads words.

5. The method of claim 2, further comprising:
subsequent to the subtitle segment being generated for display, receiving a user input to obtain more time to view the subtitle segment from the user; and
increasing the rate that the user reads words based on the received input to obtain more time to view the subtitle segment.

6. The method of claim 2, wherein determining the rate that the user reads words comprises:
determining that the rate that the user reads words is not available;
accessing a user profile associated with the user;
retrieving information from the user profile;
accessing an average rate data structure containing average rates that groups read words;
determining, based on the information from the user profile, that the user corresponds to a group; and
retrieving, from the average rate data structure, the average rate that users in the group read words as the rate that the user reads words.

7. (canceled)

8. (canceled)

9. The method of claim 2, wherein increasing the duration that the subtitle segment is generated for display comprises:
determining, based on comparing the new end time code of the subtitle segment with the start time codes associated with the subtitle segments stored in the subtitle data structure, whether any subtitle segments overlap; and
in response to determining that no subtitle segments overlap, generating the subtitle segment for display until the new end time code.

10. The method of claim 2, wherein increasing the duration that the subtitle segment is generated for display comprises:
determining frequencies of audio in frames between the start time code and the end time code for the subtitle segment;
comparing the frequencies of audio in the frames to frequencies corresponding to human speech;
comparing visual components of two adjacent frames of the frames in the media asset between the start time code and the end time code;
determining whether the visual components of the two adjacent frames are within a threshold similarity;
in response to determining that a frame of the frames between the start time code and the end time code does not contain the frequencies corresponding to human speech, storing an indication that the frame does not contain human speech; and
in response to determining that the visual components of the two adjacent frames are within the threshold similarity, storing an indication that the adjacent frames do not contain interesting visual content.

11. The method of claim 10, further comprising:
determining, based on the stored indication that the frame does not contain human speech and the stored indication that the adjacent frames do not contain interesting visual content, whether the frame and the adjacent frames overlap;
in response to determining the frame and the adjacent frames overlap, inserting a new frame during the overlapping frames; and
in response to determining the frame and the adjacent frames do not overlap, inserting the new frame with the frame that does not contain human speech.

12. A system for adjusting lengths of time subtitle segments are displayed, the system comprising:
storage circuitry; and
control circuitry configured to:
determine a rate that a user reads words;
retrieve a subtitle segment from a subtitle data structure for a media asset with a start time code and an end time code;
calculate a displayed word rate for the subtitle segment by:
determine whether the rate that the user reads words is less than the displayed word rate for the subtitle segment by calculating a rate factor by dividing the displayed word rate for the subtitle segment by the rate that the user reads words;
compare the rate factor to a minimum factor and a maximum factor;
in response to determining that the rate factor is greater than the minimum factor and that the rate factor is less than the maximum factor:
determine that the rate that the user reads words is less than the displayed word rate for the subtitle segment,
determine an increased duration to display the subtitle segment by multiplying the duration of the subtitle segment by the rate factor, wherein the increased duration ends at a new end time code, and
generate the subtitle segment for display for the increased duration;
in response to determining that the rate factor is greater than the minimum factor and that the rate factor is greater than the maximum factor, determine that the rate that the user reads words is less than the displayed word rate for the subtitle segment and that the duration of the subtitle segment cannot be adjusted by the rate factor.

13. The system of claim 12, wherein the control circuitry is further configured, when determining the rate that the user reads words, to:
access a calibration data structure;
retrieve a calibration text passage and a value for a number of words in the calibration text passage from the calibration data structure;
in response to receiving a first user input to determine the rate that the user reads words:
generate for display the calibration text passage; and
determine an initial time at which the calibration text passage was first generated for display;
in response to receiving a second user input that the user has finished reading the calibration text passage, determine an end time;
calculate a calibration duration by subtracting the initial time from the end time; and
calculate the rate that the user reads words by dividing the number of words in the calibration text passage by the calibration duration.

14. The system of claim 12, wherein the control circuitry is further configured, when determining the rate that the user reads words, to:
determine, from an indication in a user profile for the user, a first time that the user opened textual content on a mobile device;
determine a second time that the user closed the textual content after opening the textual content;
determine a number of words in the textual content; and
calculate, based on the difference between the first time and the second time and the number of words in the textual content, the rate that the user reads words.

15. The system of claim 12, wherein the control circuitry is further configured to:
subsequent to the subtitle segment being generated for display, receive a user input to obtain more time to view the subtitle segment from the user; and
increase the rate that the user reads words based on the received input to obtain more time to view the subtitle segment.

16. The system of claim 12, wherein the control circuitry is further configured, when determining the rate that the user reads words, to:
determine that the rate that the user reads words is not available;
access a user profile associated with the user;
retrieve information from the user profile;
access an average rate data structure containing average rates that groups read words;
determine, based on the information from the user profile, that the user corresponds to a group; and
retrieve, from the average rate data structure, the average rate that users in the group read words as the rate that the user reads words.

17. (canceled)

18. (canceled)

19. The system of claim 12, wherein the control circuitry is further configured to:
determine, based on comparing the new end time code of the subtitle segment with the start time codes associated with the subtitle segments stored in the subtitle data structure, whether any subtitle segments overlap; and
in response to determining that no subtitle segments overlap, generate the subtitle segment for display until the new end time code.

20. The system of claim 12, wherein the control circuitry is further configured, when increasing the duration that the subtitle segment is generated for display, to:
determine frequencies of audio in frames between the start time code and the end time code for the subtitle segment;
compare the frequencies of audio in the frames to frequencies corresponding to human speech;
compare visual components of two adjacent frames of the frames in the media asset between the start time code and the end time code;
determine whether the visual components of the two adjacent frames are within a threshold similarity;
in response to determining that a frame of the frames between the start time code and the end time code does not contain the frequencies corresponding to human speech, store an indication that the frame does not contain human speech; and
in response to determining that the visual components of the two adjacent frames are within the threshold similarity, store an indication that the adjacent frames do not contain interesting visual content.

21. The system of claim 20, wherein the control circuitry is further configured to:
determine, based on the stored indication that the frame does not contain human speech and the stored indication that the adjacent frames do not contain interesting visual content, whether the frame and the adjacent frames overlap;
in response to determining the frame and the adjacent frames overlap, insert a new frame during the overlapping frames; and
in response to determining the frame and the adjacent frames do not overlap, insert the new frame with the frame that does not contain human speech.

22-51. (canceled)
